(19) United States
(12) Patent Application Publication
(10) Pub. No.: US 2023/0101396 A1
(43) Pub. Date: Mar. 30, 2023

(54) METHODS, SYSTEMS, APPARATUSES, AND DEVICES FOR FACILITATING CHARGING OF ELECTRIC VEHICLES

(71) Applicant: Mayur Mukund Kamalakar, Tyngsboro, MA (US)

(72) Inventor: Mayur Mukund Kamalakar, Tyngsboro, MA (US)

(21) Appl. No.: 18/077,263

(22) Filed: Dec. 8, 2022

Related U.S. Application Data
(60) Provisional application No. 63/320,751, filed on Mar. 17, 2022.

(51) Int. Cl. B60L 53/31; B60L 53/51; H02S 20/23

(52) U.S. Cl. CPC B60L 53/31; B60L 53/51; H02S 20/23; H02S 20/30

(57) ABSTRACT

A charging apparatus for facilitating charging of electric vehicles. The charging apparatus comprises a charging structure, a solar panel, and charging stations. The charging structure is movably positionable on a surface. The charging structure comprises a leg movably erected on the surface and a roof structure comprising two frame pairs supported on the leg. Further, a first frame pair and a second frame pair laterally extend away from a first side and a second side of a top end of the leg and are upwardly inclined with respect to the leg. The first frame and the second frame are upwardly inclined with respect to an attachment axis of the first frame and the second frame. The solar panel is mounted on the roof structure. The charging stations charge electric vehicles based on receiving electrical energy from the solar panel and an electrical grid.

### CROSS-REFERENCE TO RELATED APPLICATION

This application claims the benefit of U.S. Provisional Patent Application No. 63/320,751, titled “METHODS, SYSTEMS, APPARATUSES, AND DEVICES FOR FACILITATING CHARGING ELECTRIC VEHICLES”, filed 17 Mar. 2022, which is incorporated by reference herein in its entirety.

### FIELD OF THE INVENTION

Generally, the present disclosure relates to the field of data processing. More specifically, the present disclosure relates to methods, systems, apparatuses, and devices for facilitating charging of electric vehicles.

### BACKGROUND OF THE INVENTION

Regular utility electric supply powered EV charging stations are installed at commercial places (mall parking lots, town halls) for people to charge their electric vehicles. Most of these existing charging stations come with only one plug and can charge only one car at a time.

Existing charging units for charging electric vehicles are deficient in regard to several aspects. For instance, current charging units have structures acting as roofs, and snow falling on these roofs accumulates or falls in a pathway associated with the current charging structure. As a result, different charging units are needed with roofs that prevent the falling of the snow on the pathway. Furthermore, current charging units are designed to be stationarily erected in a particular location. As a result, different charging units are needed that move around.

Therefore, there is a need for improved methods, systems, apparatuses, and devices for facilitating charging of electric vehicles that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a charging apparatus for facilitating charging of electric vehicles, in accordance with some embodiments. Accordingly, the charging apparatus may include a charging structure, at least one solar panel, and one or more charging stations. Further, the charging structure may be movably positionable on a surface of a location. Further, the charging structure may include at least one leg movably erected on the surface and at least one roof structure supported on the at least one leg. Further, each of the at least one roof structure corresponding to each of the at least one leg may include two frame pairs. Further, a first frame pair of two frame pairs laterally extends away from a first side of a top end of each of the at least one leg and a second frame pair of the two frame pairs laterally extends away from a second side opposite to the first side of the top end. Further, the first frame pair and the second frame pair may be upwardly inclined with respect to each of the at least one leg. Further, each of the first frame pair and the second frame pair may include a first frame and a second frame attached to the first frame forming an attachment axis. Further, the first frame and the second frame may be upwardly inclined with respect to the attachment axis. Further, the at least one solar panel may be mounted on the at least one roof structure. Further, the at least one solar panel may include two solar panel pairs. Further, a first solar panel pair of the two solar panel pairs may be attached in the first frame pair and a second solar panel pair of the two solar panel pairs may be attached in the second frame pair. Further, a first solar panel of each of the first solar panel pair and the second solar panel pair may be attached in the first frame and a second solar panel of each of the first solar panel pair and the second solar panel pair may be attached in the second frame. Further, the one or more charging stations may be electrically coupled with at least one of the at least one solar panel and an electrical grid. Further, the one or more charging stations may be configured for receiving electrical energy from at least one of the at least one solar panel and the electrical grid. Further, the one or more charging stations may be configured for charging one or more electric vehicles using one or more connectors based on the receiving of the electrical energy. Further, the one or more connectors electrically connects the one or more charging stations to one or more charging ports of the one or more electric vehicles.

Further, disclosed herein is a charging apparatus for facilitating charging of electric vehicles, in accordance with some embodiments. Accordingly, the charging apparatus may include a charging structure, at least one solar panel, one or more charging stations, at least one first sensor, a processing device, and a communication device. Further, the charging structure may be movably positionable on a surface of a location. Further, the charging structure may include at least one leg movably erected on the surface and at least one roof structure supported on the at least one leg. Further, each of the at least one roof structure corresponding to each of the at least one leg may include two frame pairs. Further, a first frame pair of two frame pairs laterally extends away from a first side of a top end of each of the at least one leg and a second frame pair of the two frame pairs laterally extends away from a second side opposite to the first side of the top end. Further, the first frame pair and the second frame pair may be upwardly inclined with respect to each of the at least one leg. Further, each of the first frame pair and the second frame pair may include a first frame and a second frame attached to the first frame forming an attachment axis. Further, the first frame and the second frame may be upwardly inclined with respect to the attachment axis. Further, the at least one solar panel may be mounted on the at least one roof structure. Further, the at least one solar panel may include two solar panel pairs. Further, a first solar panel pair of the two solar panel pairs may be attached in the first frame pair and a second solar panel pair of the two solar panel pairs may be attached in the second frame pair. Further, a first solar panel of each of the first solar panel pair and the second solar panel pair may be attached in the first frame and a second solar panel of each of the first solar panel pair and the second solar panel pair may be attached in the second frame. Further, the one or more charging stations may be electrically coupled with at least one of the at least one solar panel and an electrical grid. Further, the one or more charging stations may be configured for receiving electrical energy from at least one of the at least one solar panel and the electrical grid. Further, the one or more charging stations may be configured for charging one or more electric vehicles using one or more connectors based on the receiving of the electrical energy. Further, the one or more connectors electrically connects the one or more charging stations to one or more charging ports of the one or more electric vehicles. Further, the at least one first sensor may be configured for generating at least one first sensor data based on detecting at least one parameter associated with the receiving of the electrical energy. Further, the processing device may be communicatively coupled with the at least one first sensor. Further, the processing device may be configured for analyzing the at least one first sensor data. Further, the processing device may be configured for generating an energy generation report associated with the receiving of the electrical energy based on the analyzing. Further, the communication device may be communicatively coupled with the processing device. Further, the communication device may be configured for transmitting the energy generation report to at least one device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a perspective view of a charging apparatus for facilitating charging of electric vehicles with one or more electric vehicles, in accordance with some embodiments.

FIG. 2 is a right side view of the charging apparatus, in accordance with some embodiments.

FIG. 3 is a right side view of the charging apparatus, in accordance with some embodiments.

FIG. 4 is a right side view of the charging apparatus, in accordance with some embodiments.

FIG. 5 is a right side view of the charging apparatus, in accordance with some embodiments.

FIG. 6 is a right side view of the charging apparatus, in accordance with some embodiments.

FIG. 7 is a right side view of the charging apparatus, in accordance with some embodiments.

FIG. 8 is a right side view of the charging apparatus, in accordance with some embodiments.

FIG. 9 is a left side view of the charging apparatus, in accordance with some embodiments.

FIG. 10 is a front perspective view of the charging apparatus with the one or more electric vehicles, in accordance with some embodiments.

FIG. 11 is a left side view of the charging apparatus with the one or more electric vehicles, in accordance with some embodiments.

FIG. 12 is a left side view of the charging apparatus with a moving vehicle, in accordance with some embodiments.

FIG. 13 is a left side view of the charging apparatus with the one or more electric vehicles and the at least one precipitation, in accordance with some embodiments.

FIG. 14 is a rear perspective view of the charging apparatus with the one or more electric vehicles, in accordance with some embodiments.

FIG. 15 is a front view of a charging apparatus for facilitating charging of electric vehicles, in accordance with some embodiments.

FIG. 16 is a perspective view of a charging apparatus for facilitating charging of electric vehicles with one or more electric vehicles, in accordance with some embodiments.

FIG. 17 is a flowchart of a method for facilitating charging of at least one electric vehicle (EV) using a charging unit, in accordance with some embodiments.

FIG. 18 is a block diagram of a system for facilitating charging of at least one electric vehicle (EV) using a charging unit, in accordance with some embodiments.

FIG. 19 is a perspective view of a charging apparatus with at least one electric vehicle, in accordance with some embodiments.

FIG. 20 is a left side view of the charging apparatus, in accordance with some embodiments.

FIG. 21 is a left side view of the charging apparatus, in accordance with some embodiments.

FIG. 22 is a left side view of the charging apparatus, in accordance with some embodiments.

FIG. 23 is a left side view of the charging apparatus, in accordance with some embodiments.

FIG. 24 is a perspective view of the charging apparatus with the at least one electric vehicle, in accordance with some embodiments.

FIG. 25 is a perspective view of the charging apparatus with the at least one electric vehicle, in accordance with some embodiments.

FIG. 26 is a perspective view of the charging apparatus with the at least one electric vehicle, in accordance with some embodiments.

FIG. 27 is a front view of the charging apparatus with the at least one electric vehicle, in accordance with some embodiments.

FIG. 28 is a left side view of the charging apparatus with the at least one electric vehicle, in accordance with some embodiments.

FIG. 29 is a left side view of the charging apparatus with a driving mechanism, in accordance with some embodiments.

FIG. 30 is a left side view of the charging apparatus with the at least one electric vehicle, in accordance with some embodiments.

FIG. 31 is a rear view of the charging apparatus with the at least one electric vehicle, in accordance with some embodiments.

FIG. 32 is an illustration of an online platform consistent with various embodiments of the present disclosure.

FIG. 33 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating charging of electric vehicles, embodiments of the present disclosure are not limited to use only in this context.

In general, the method disclosed herein may be performed by one or more computing devices. For example, in some embodiments, the method may be performed by a server computer and/or a computing device in communication with one or more client devices over a communication network such as the Internet. In some other embodiments, the method may be performed by one or more of at least one server computer, at least one computing device, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer or the computing device may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the processing device may include a processing unit. Further, the server computer or the computing device may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Further, the communication device may include a communication interface. Accordingly, the communication device may be configured for performing one or more of transmitting and receiving of information in electronic form. Further, the server computer or the computing device may include a storage device configured for performing data storage and/or data retrieval operations. Further, the storage device may include a memory. In general, the storage device may be configured for providing reliable storage of digital information. Accordingly, in some embodiments, the storage device may be based on technologies such as but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating charging of electric vehicles. Further, the disclosed system may include an electric vehicle charging station (or charging unit). Further, the electric vehicle charging station may be smart, solar-powered, and mobile. Further, the electric vehicle charging station may be used for residential and commercial use.

Further, any user either commercial or residential may charge an EV (or electric vehicle) using the smart solar-powered mobile electric vehicle charging station. Further, the electric vehicle charging station may be installed in a parking lot of a house, solar panels may be installed on a rectangular structure with a customizable (adjustable) height based on the EV. Further, the solar panels may act as a shade and protect the EV from sunlight in summers and snow in winters. Further, the rectangular structure may be installed with a certain tilt (or slope). Further, the slope may not allow snow to fall on a pathway keeping the pathway always clear of snow in winters. Further, the electric vehicle charging station may be used for personal residential use and commercial use and may be relocated. Also, the electric vehicle charging station may be considered an independent unit and may not rely on any other source for electric supply. Further, an option may be provided in the electric vehicle charging station during non-sunny days to get charged from a regular electric supply, but it's not recommended. Further, most of the days in the year the electric vehicle charging station may be powered by solar energy.

Further, regular charging stations have the capability to charge only one car, but the electric vehicle charging station has two plugins and may charge two vehicles simultaneously and reach up to twenty parking spots. Further, the electric vehicle charging station may be monitored remotely from a free phone application.

Further, in some embodiments, the electric vehicle charging station may have two or more plugins and may charge two or more electric vehicles simultaneously, and may reach more than twenty parking spots.

Further, a commercial version of the electric vehicle charging station may come with a special scannable barcode for a charging unit of the smart solar-powered mobile electric vehicle charging station. Further, the user may pay after charging the EV by scanning the special scannable barcode. Further, a plurality of commercial users may download a smart solar EV charging app for free from any phone and may monitor their vehicle charging status. Further, a text message and email with a billing receipt may be sent to the plurality of commercial users' emails once the charging is complete.

Further, for residential users, an option may be provided to an owner of a charging unit of the electric vehicle charging station to rent/lease the charging unit for others to use and charge their vehicles. Further, renting may also allow the owner of the charging unit to sell his/her extra energy produced from the solar panels and make some passive income.

Further, for residential use, the electric vehicle charging station comes with a dual plugin option that may charge two cars at the same time. Further, charging plugin wires may reach up to 20 parking spots. Further, the electric vehicle charging station may be accessed and monitored from anywhere by the users. Further, the solar panels installed on the electric vehicle charging station may provide shade to cars. Further, solar energy may be a primary source of energy to power the electric vehicle charging station but the electric vehicle charging station may also have a backup electricity supply. Further, the electric vehicle charging station may be equipped with plugin solutions to charge emergency vehicles and first responders for free. Further, a residential owner of the electric vehicle charging station may also rent it to other users for charging and thus may make passive income. Further, the charging unit may not be fixed to the ground and is movable, thus if the residential owner decides to relocate, he/she may easily move the complete charging unit. Further, most EV charging stations are owned by owners and not landlords so when a lease is over the owner may move the electric vehicle charging station to a new location. Further, the electric vehicle charging station may be off-grid so an individual may use it also during blackout hours and grid interruptions. Further, the electric vehicle charging station also has an option to provide electricity to first responders. For commercial use, the electric vehicle charging station may charge up to two electric vehicles at a time and the cable may reach up to twenty parking spaces. Further, a battery may be stored underground thus providing more area on the ground. For commercial use, the electric vehicle charging station comes with a Wi-Fi payment option, that may use the Wi-Fi feature from the credit cards to do payments without using cash or inserting a credit card. Tap the credit card and it may be fine. Registered users may also download the free mobile application to track the status of their charging. Further, construction, permitting, electrical work, and electric bills may not be required. Further, installation cost, labor, and county permitting may not be required, a setup of the electric vehicle charging station comes as a whole unit and may be installed at the desired location.

Further, a need for the electric vehicle charging station may have arisen as the EV market is growing and so the dependency on charging them is increasing. Using renewable power at no cost may be the best way to save on energy and charge electric vehicles. Further, the electric vehicle charging station may help in reducing carbon footprint as it is free, and abundantly available solar energy may be used to charge EVs. Further, most of the leading car manufacturers are working on launching electric vehicles, thus powering them using solar may be the best solution.

Further, many EV charging stations in the market may be available but using solar power directly to power EV charging may be something new. Further, the electric vehicle charging station may charge two vehicles at a time and may reach up to twenty parking spots. Further, a free phone application also provides user details on real-time charging status. Further, payments may be done on the free phone application or a contactless wireless credit card may be used. User may easily relocate the setup if he/she moves to a new location. Residential users may also let others use the electric vehicle charging station and may earn passive income. For first responders, an option may be available to use the power from the electric vehicle charging station for free during an emergency.

Further, the electric vehicle charging station may be considered a simple device that uses solar panels and a battery for storage as the main components. The battery may be installed in the ground that comes insulated to protect from snow/water and bypass other electrical currents. Further, a stand for the display panel supports the display screen and has a hanger to support two plugin wires. Further, a support structure may support the solar panels. Further, the solar panels may be installed in a fashion to provide shade to the car. Further, the plugin wire has a charging plug that may be inserted into the EV to charge the EV.

Solar power that is a free source of energy and available abundantly may be used in the smart solar-powered mobile electric vehicle charging station. Further, using solar power may help to protect the environment by reducing pollution and overall carbon footprint. Further, a complete unit of the electric vehicle charging station may be pre-structured and requires no installation, placed at a site, and ready to use. Further, permitting or electric supply from the grid may not be required. Further, payments may be done on the free phone application, or contactless/wireless credit cards may be used. Further, the solar panels may provide shade to the cars and thus protect them from direct sun rays. Further, the electric vehicle charging station may be associated with sustainable EV charging. Further, the technology for EV charging (or smart charging) by the electric vehicle charging station may be one of its kind and very new.

Further, the present disclosure describes a charging unit for facilitating charging of electric vehicles.

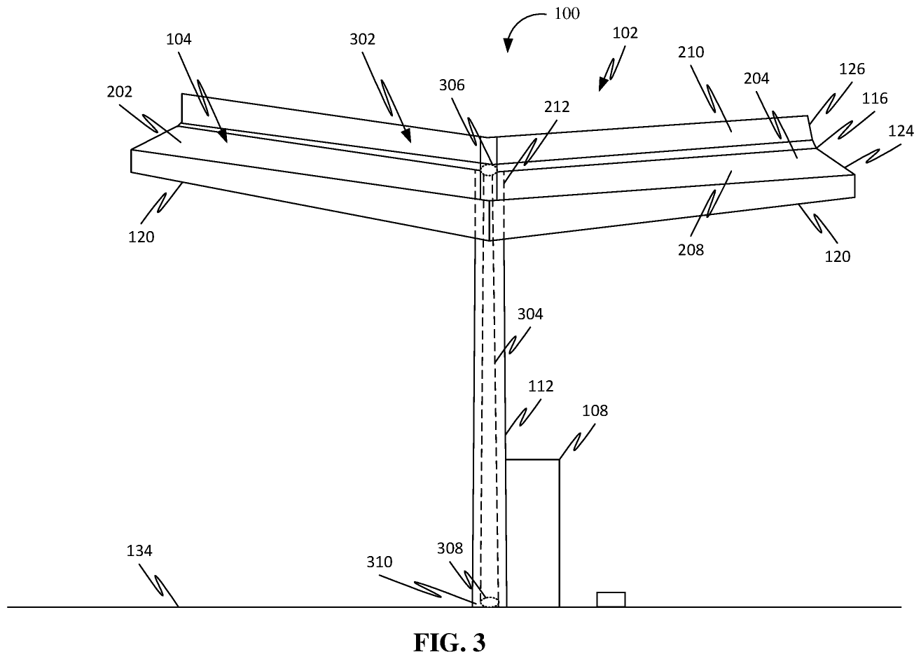

Further, the charging unit may be configured for facilitating the charging of an EV (or electric vehicle). Further, the charging unit may include a plurality of solar panels (or solar panels) and a battery. Further, the plurality of solar panels may be supported by at least one support structure. Further, the plurality of solar panels may be configured to convert solar energy into electrical energy. Further, the plurality of solar panels may act as a shade and protect the EV from sunlight in summers and snow in winters. Further, the battery may be used for the storage of electricity (or electrical energy). Further, the battery may be disposed underground for providing more area on the ground. Further, the battery may be configured to supply electricity to the EV through at least one plugin wire. Further, the at least one plugin wire may include a charging plug at one end that may be inserted in a charging socket of the EV during the charging. Further, in an instance, the other end of the at least one plugin wire may be electrically connected to the battery. Further, in an instance, the other end of the at least one plugin wire may be electrically connected to the solar panels. Further, at least one support structure may be installed on the ground with a certain tilt (or slope). Further, the slope may not allow snow to fall on a pathway keeping the pathway always clear of snow in winters. Further, the slope may allow the snow to fall behind (as shown in FIG. 3). Further, the at least one support structure may come with a customizable (adjustable) height. Further, the at least one support structure may be configured for carrying compressive loads. Further, the at least one support structure may be made of stainless steel, alloys, plastic, or any other noncorrosive metal. Further, the at least one plugin wire may be configured to supply electricity to the EV during charging. Further, the charging unit may include a display panel. Further, a stand may support the display panel. Further, the stand may include a hanger to support the at least one plugin wire. Further, the display panel may be configured for displaying at least one charging information. Further, the at least one charging information may include energy supplied to the EV, cost of charging, time for charging, etc. Further, the EV may include electric cars, electric trucks, electric motorcycles, electric two-wheelers, electric three-wheelers, electric four-wheelers, or any other vehicle that in an instance, may be able to be electrically powered. Further, the charging unit may be configured to be relocated to a new location. Furthermore, the charging unit may be configured to charge multiple EVs simultaneously. Further, the charging unit may include an electric supply connection. Further, the electric supply connection may be configured for charging the EV during non-sunny days. Further, the electric supply connection may be configured for charging the EV during the unavailability of solar energy for charging the EV.

Further, the charging unit may include a single-axis solar tracking system (solar tracking device) employed for tracking the position of the sun and accordingly changing the orientation of the plurality of solar panels. Further, the single-axis solar tracking system may include at least one light detecting sensor. Further, the at least one light detecting sensor may be configured for detecting the position of the sun. Further, the single-axis solar tracking system may include a plurality of actuators. Further, the plurality of actuators may be configured for changing the orientation of the plurality of solar panels. Further, the single-axis solar tracking system may include a communication device configured for receiving at least one sun orientation data from the at least one light detecting sensor. Further, Further, the single-axis solar tracking system may include a processing device communicatively coupled with the communication device. Further, the processing device may be configured for analyzing the at least one sun orientation data. Further, the processing device may be configured for generating a command based on the analyzing. Further, the communication device may be communicatively coupled with the at least one light detecting sensor and the plurality of actuators. Further, the communication device may be configured for transmitting the command to the plurality of actuators. Further, the plurality of actuators may be configured to change the orientation of the plurality of solar panels based on the receiving of the command. Further, the processing device may be communicatively coupled with the communication device.

Further, the plurality of solar panels may be foldable using a folding mechanism for convenient storage. Further, the folding mechanism may include at least one of a prismatic joint, a hinge joint, a pivot, etc.

Further, the present disclosure describes a driving mechanism for the charging unit. Further, the charging unit may include the driving mechanism. Further, the driving mechanism may be a vehicle for moving the charging unit. Further, the driving mechanism may be configured for allowing the charging unit to be driven from a first location to a second location. Further, the driving mechanism may be manually operated by an operator. Further, the operator is an individual that may drive the charging unit from the first location to the second location. Further, the driving mechanism may include a steering wheel. Further, the driving mechanism may include a propulsion mechanism. Further, the propulsion mechanism may be configured for generating power that may be used for moving the charging unit. Further, the driving mechanism may include a braking system. Further, the braking system may be configured for stopping a linear motion of the charging unit. Further, the driving mechanism may include a clutching system. Further, the driving mechanism may include a plurality of wheels. Further, the plurality of wheels may be configured to roll on the ground for providing a smooth motion to the charging unit. Further, the plurality of wheels may be mechanically coupled with the propulsion mechanism. Further, the propulsion may Further, the plurality of wheels may be made of rubber, a combination of rubber and chemicals, metals, etc. Further, the driving mechanism may be configured to be manually operated. Further, the driving mechanism may be operated by the operator.

Further, the driving mechanism may be self-operating. Further, the driving mechanism may include one or more input devices. Further, the one or more input devices may include sensors, cameras, and a radar. Further, the driving mechanism may include a plurality of actuators. Further, the driving mechanism may include a communication device configured for receiving a position data from the sensors. Further, the position data may be associated with the position of the charging unit. Further, the communication device may be configured for receiving a surrounding data from the cameras. Further, the surrounding data may be associated with a plurality of objects in the surrounding of the charging unit. Further, the communication device may be configured for receiving a distance data from the radar. Further, the distance data may be associated with the distances of the plurality of objects from the charging unit. Further, the driving mechanism may include a processing device configured for analyzing the position data, the surrounding data, and the distance data using an artificial intelligence model. Further, the artificial intelligence model may be trained for assisting in moving the charging unit for relocating between destinations without a human operator. Further, the processing device may be configured for generating at least one motion command based on the analyzing. Further, the communication device may be configured for transmitting the at least one motion command to the plurality of actuators. Further, the plurality of actuators may be configured to move the charging unit based on the at least one motion command.

Further, the communication device may be configured for receiving navigation data from at least one user device associated with at least one user. Further, the generating of the motion command may be based on the navigation data. Further, the navigation data may include location information of the first location (or initial point) and the second location (or destiny). Further, the at least one user may want to relocate the charging unit from the starting point to the destiny. Further, the location information may include a location coordinate, location name, location address, etc.

Further, the present disclosure describes a charging apparatus comprising four charging stations, two are slow charging stations while the other two are fast charging stations. Further, the charging apparatus is not a 100% solar powered system. Further, the charging apparatus is hybrid and uses solar and utility grid power. Further, the charging apparatus may include a structure that is metallic. Further, the metallic structure of carport roofs is designed with tilt for a reason for passage to snow and to increase the efficiency of solar panels by tilt. Further, the structure is installed on concrete blocks but is easily movable when dismantled.

Further, the present disclosure describes an interactive kiosk, installed, for example on the sides of the pillars of the charging station. The interactive kiosk may be configured to allow users to place food orders which are then transmitted to partner restaurants to service them. Further, the present disclosure describes the setting up of the charging station in the open parking space of the restaurants. Further, the setting up of the charging station in the open parking spaces allows partnering of the charging station providers with the restaurants to maintain the charging station and along with sharing profits generated from the charging and the food orders being placed via the kiosk at the charging station.

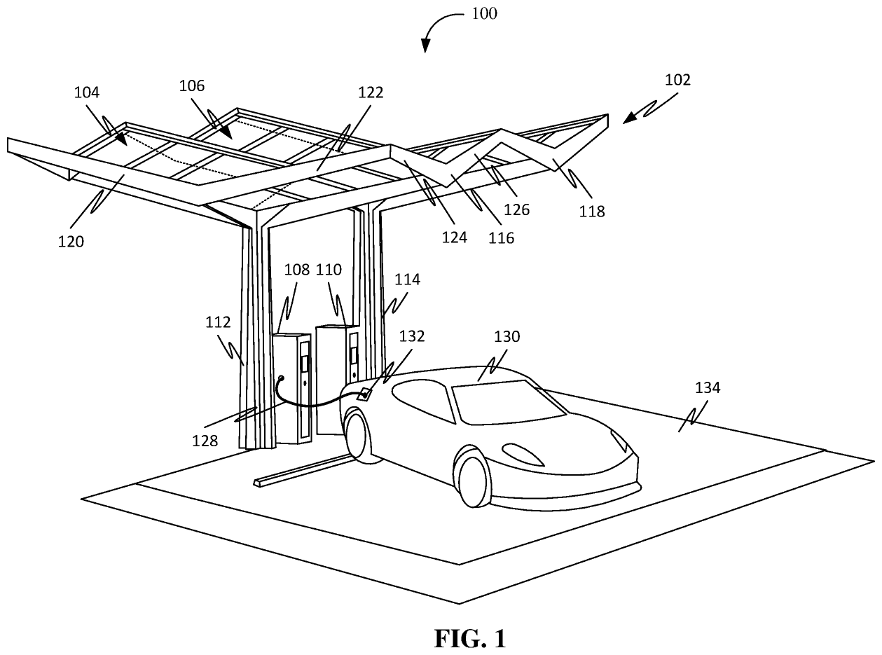

FIG. 1 is a perspective view of a charging apparatus 100 for facilitating charging of electric vehicles with one or more electric vehicles 130, in accordance with some embodiments. Accordingly, the charging apparatus 100 may include a charging structure 102, at least one solar panel 104-106, and one or more charging stations 108-110. Further, the charging apparatus 100 may be a charging unit.

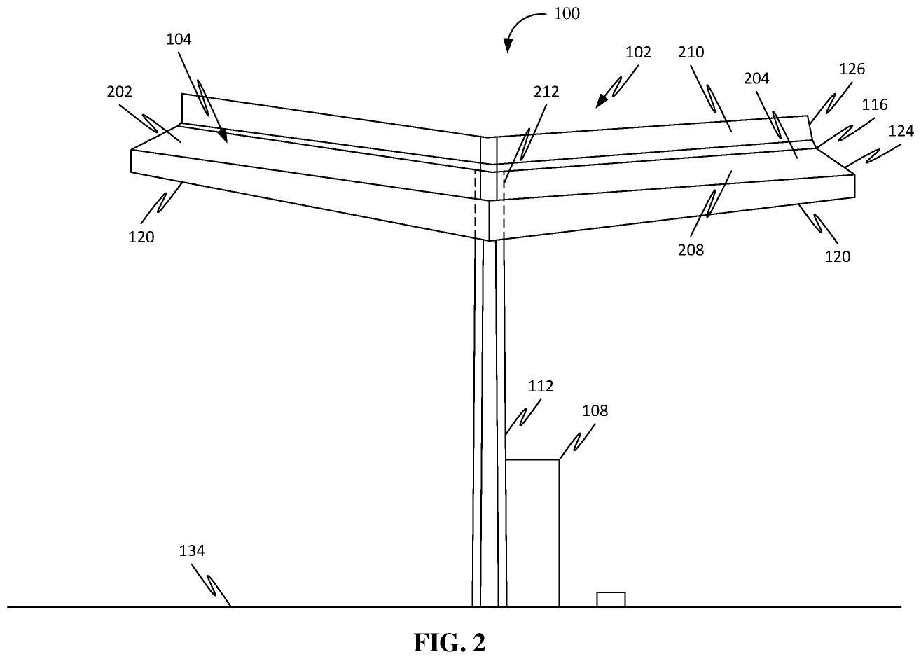

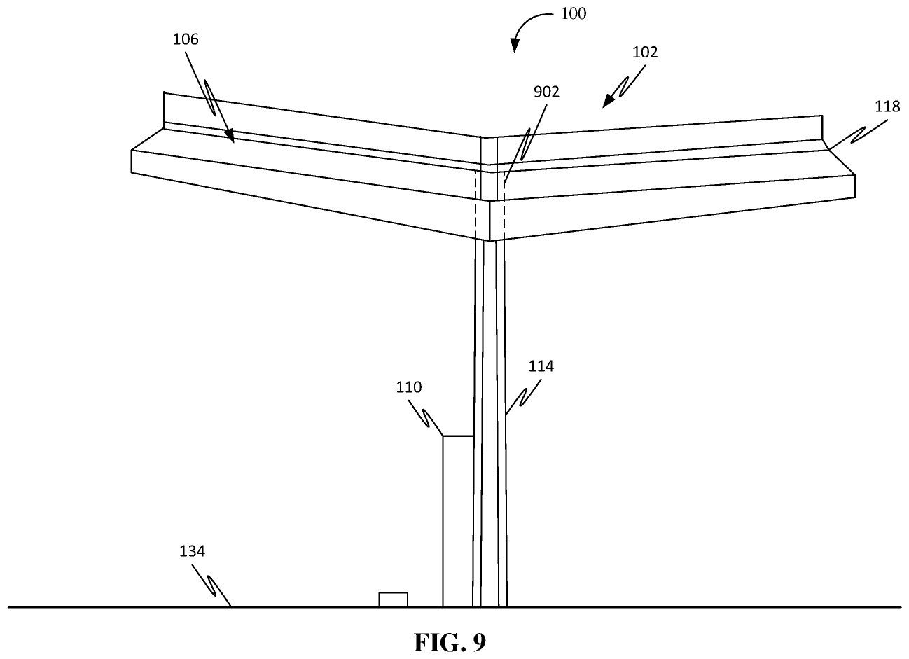

Further, the charging structure 102 may be movably positionable on a surface 134 of a location. Further, the location may include a parking lot, a town hall, a gas station, a parking space, etc. Further, the location may be associated with at least one facility such as a restaurant, etc. Further, the charging structure 102 may include at least one leg 112-114 movably erected on the surface 134 and at least one roof structure 116-118 supported on the at least one leg 112-114. Further, each of the at least one roof structure 116-118 corresponding to each of the at least one leg 112-114 may include two frame pairs 120-122. Further, a first frame pair 120 of two frame pairs 120-122 laterally extends away from a first side of a top end (212 and 902), as shown in FIG. 2 and FIG. 9, of each of the at least one leg 112-114 and a second frame pair 122 of the two frame pairs 120-122 laterally extends away from a second side opposite to the first side of the top end (212 and 902). Further, the first frame pair 120 and the second frame pair 122 may be upwardly inclined with respect to each of the at least one leg 112-114. Further, each of the first frame pair 120 and the second frame pair 122 may include a first frame 124 and a second frame 126 attached to the first frame 124 forming an attachment axis. Further, the first frame 124 and the second frame 126 may be upwardly inclined with respect to the attachment axis.

Further, the at least one solar panel 104-106 may be mounted on the at least one roof structure 116-118. Further, the at least one solar panel 104-106 may include two solar panel pairs 202-204, as shown in FIG. 2. Further, a first solar panel pair 202 of the two solar panel pairs 202-204 may be attached in the first frame pair 120 and a second solar panel pair 204 of the two solar panel pairs 202-204 may be attached in the second frame pair 122. Further, a first solar panel 208, as shown in FIG. 2, of each of the first solar panel pair 202 and the second solar panel pair 204 may be attached in the first frame 124 and a second solar panel 210, as shown in FIG. 2, of each of the first solar panel pair 202 and the second solar panel pair 204 may be attached in the second frame 126.

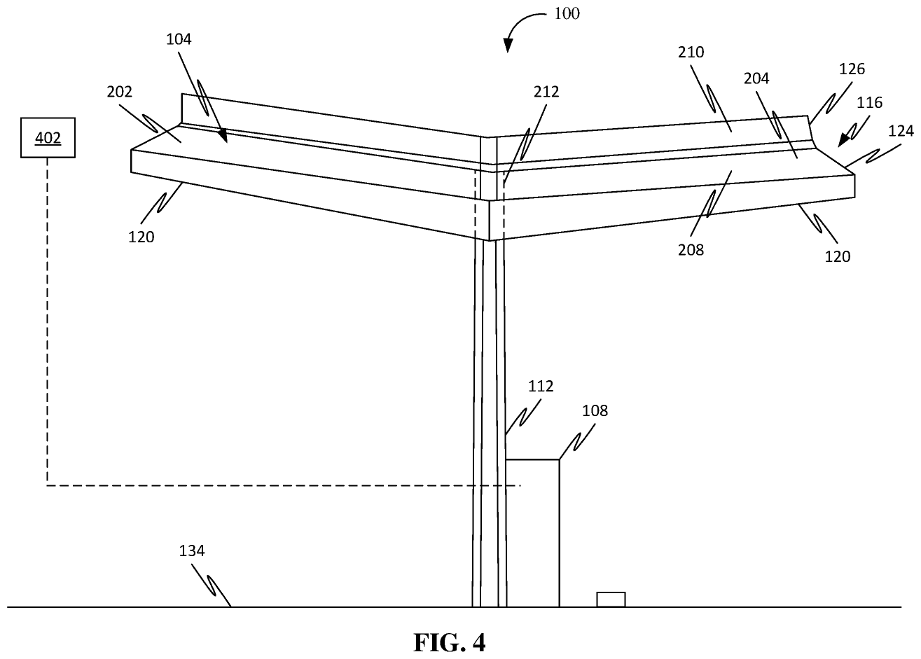

Further, the one or more charging stations 108-110 (charging device) may be electrically coupled with at least one of the at least one solar panel 104-106 and an electrical grid 402, as shown in FIG. 4. Further, the one or more charging stations 108-110 may be configured for receiving electrical energy from at least one of the at least one solar panel 104-106 and the electrical grid 402. Further, the one or more charging stations 108-110 may be configured for charging the one or more electric vehicles 130 using one or more connectors 128 based on the receiving of the electrical energy. Further, the charging may include transferring the electrical energy to one or more batteries of the one or more electric vehicles 130 using the one or more connectors 128 via the one or more charging ports 132. Further, the one or more connectors 128 electrically connects the one or more charging stations 108-110 to one or more charging ports 132 of the one or more electric vehicles 130. Further, the one or more charging stations 108-110 may be at least one of an electric and/or electronic circuitry that electrically connects the at least one solar panel 104-106 to the one or more electric vehicles 130 using the one or more connectors 128 for allowing transfer of the electrical energy from at least one of the at least one solar panel 104-106 and the electric grid 402 to the one or more electric vehicles 130.

Further, in some embodiments, the mounting of the at least one solar panel 104-106 on the at least one roof structure 116-118 defines a recessed area 302, as shown in FIG. 3, on a top side of the at least one roof structure 116-118. Further, each of the at least one leg 112-114 may include a hollow interior 304, a top opening 306 disposed on the top end (212 and 902), and a bottom opening 308 disposed on a bottom end 310 of each of the at least one leg 112-114. Further, the top opening 306 and the bottom opening 308 may be fluidly coupled through the hollow interior 304. Further, the recessed area 302 collects at least one precipitation falling on the top side of the at least one roof structure 116-118 and removes the at least one precipitation through the hollow interior 304 based on transferring the at least one precipitation to the hollow interior 304 from the top opening 306 and exiting the at least one precipitation from the hollow interior 304 through the bottom opening 308. Further, the at least one precipitation may include rain, snow, hail, etc.

Further, in some embodiments, the at least one roof structure 116-118 may be detachably supported on the at least one leg 112-114.

Further, in some embodiments, the at least one solar panel 104-106 may include a bifacial solar panel.

Further, in some embodiments, the one or more charging stations 108-110 may be associated with one or more charging rates. Further, the charging of the one or more electric vehicles 130 using the one or more connectors 128 may include charging the one or more electric vehicles 130 with the one or more charging rates using the one or more connectors 128 based on the receiving of the electrical energy. Further, the one or more charging rates may include a first charging rate associated with a first charging station 108 of the one or more charging stations 108-110 and a second charging rate associated with a second charging station 110 of the one or more charging stations 108-110. Further, the first charging rate may be higher than the second charging rate.

Further, in some embodiments, each of the first solar panel 208 and the second solar panel 210 may be associated with at least one orientation based on the upwardly inclining of the first frame 124 and the second frame 126 with respect to the attachment axis and the upwardly inclining of the first frame pair 120 and the second frame pair 122 with respect to each of the at least one leg 112-114. Further, the at least one solar panel 104-106 generates the electrical energy with an efficiency based on the at least one orientation of each of the first solar panel 208 and the second solar panel 210.

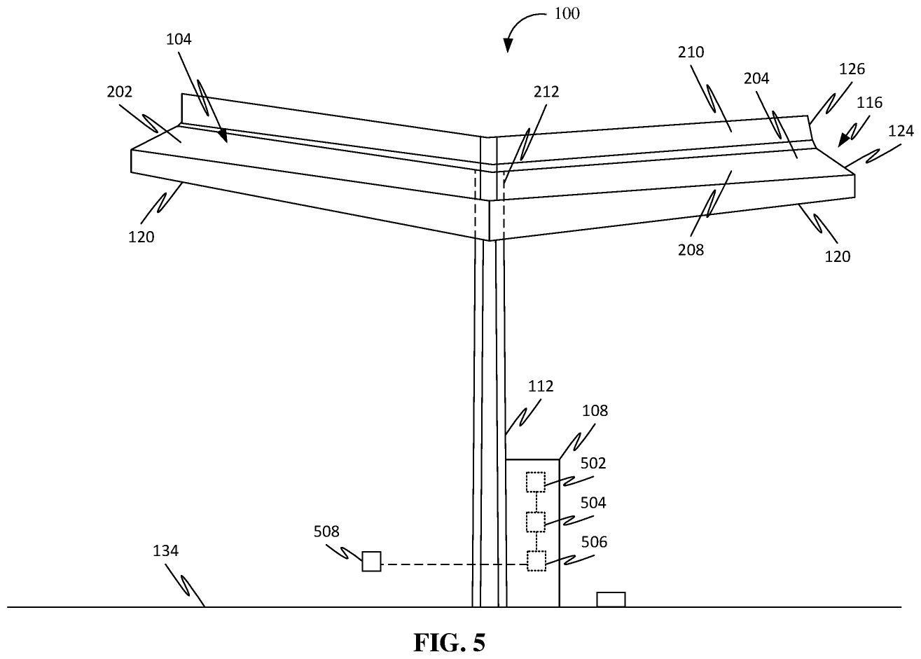

In further embodiments, the charging apparatus 100 may include at least one first sensor 502, a processing device 504, and a communication device 506, as shown in FIG. 5. Further, the at least one first sensor 502 may be configured for generating at least one first sensor data based on detecting at least one parameter associated with the receiving of the electrical energy. Further, the at least one first sensor 502 may include an electric energy meter, a voltage sensor, a current sensor, a power sensor, a frequency sensor, etc. Further, the at least one parameter may include electrical units, voltage level, power level, current level, frequency, AC/DC, etc. of the electrical energy received by the one or more charging stations 108-110. Further, the processing device 504 may be communicatively coupled with the at least one first sensor 502. Further, the processing device 504 may be configured for analyzing the at least one first sensor data. Further, the processing device 504 may be configured for generating an energy generation report associated with the receiving of the electrical energy based on the analyzing. Further, the energy generation report may include units, voltage level, power level, current level, etc. of the electrical energy generated over at least one time period. Further, the communication device 506 may be communicatively coupled with the processing device 504. Further, the communication device 506 may be configured for transmitting the energy generation report to at least one device 508, as shown in FIG. 5. Further, the at least one device 508 may include a client device, a computing device, a cloud server, an output device, etc.

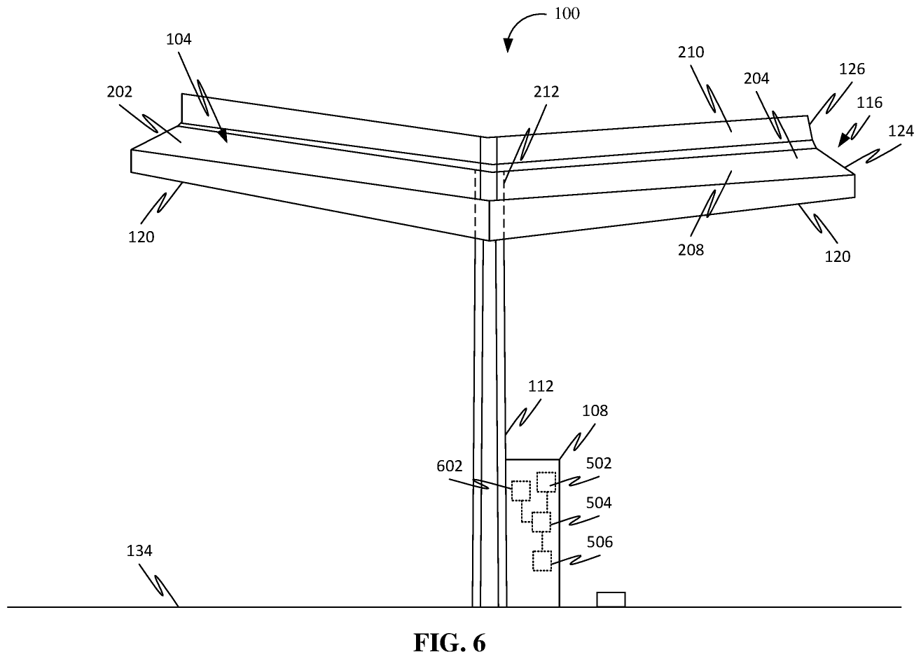

In further embodiments, the charging apparatus 100 may include at least one second sensor 602, as shown in FIG. 6, communicatively coupled with the processing device 504. Further, the at least one second sensor 602 may include an electric energy meter, a voltage sensor, a current sensor, a power sensor, a frequency sensor, a temperature sensor, etc. Further, the at least one second sensor 602 may be configured for generating at least one second sensor data based on detecting at least one charging parameter associated with the charging of the one or more electric vehicles 130. Further, the at least one charging parameter may include a charging voltage, a charging current, a charging power, an electrical unit transfered, a charging rate, a charging duration, a battery power level, a battery temperature, etc. Further, the processing device 504 may be configured for analyzing the at least one second sensor data. Further, the processing device 504 may be configured for generating a charging report associated with the charging of the one or more electric vehicles 130 based on the analyzing of the at least one second sensor data. Further, the charging report may include a duration for completing charging, a current battery power level, a number of electrical units transferred, etc. Further, the communication device 506 may be configured for transmitting the charging report to the at least one device.

Further, in an embodiment, the communication device 506 may be configured for receiving at least one of a plurality of energy generation reports and a plurality of charging reports associated with a plurality of charging apparatuses from the at least one device. Further, the plurality of charging apparatuses may be located in a plurality of locations. Further, the processing device 504 may be configured for analyzing at least one of the plurality of energy generation reports and the plurality of charging reports. Further, the processing device 504 may be configured for determining a viability of the charging apparatus 100 in the location based on the analyzing of at least one of the plurality of energy generation reports and the plurality of charging reports. Further, the viability corresponds to a performance of the charging apparatus 100 in relation to the plurality of charging apparatuses. Further, the performance may be measured by considering an amount of electrical units received by the one or more charging stations 108-110 and an amount of electrical units transferred by the one or more charging stations 108-110 during one or more time periods. Further, the processing device 504 may be configured for generating a recommendation for the charging apparatus 100 based on the determining. Further, the recommendation may include an information about retaining the charging apparatus 100 in the location. Further, the recommendation may include an information about moving the charging apparatus 100 to a different location. Further, the communication device 506 may be configured for transmitting the recommendation to the at least one device.

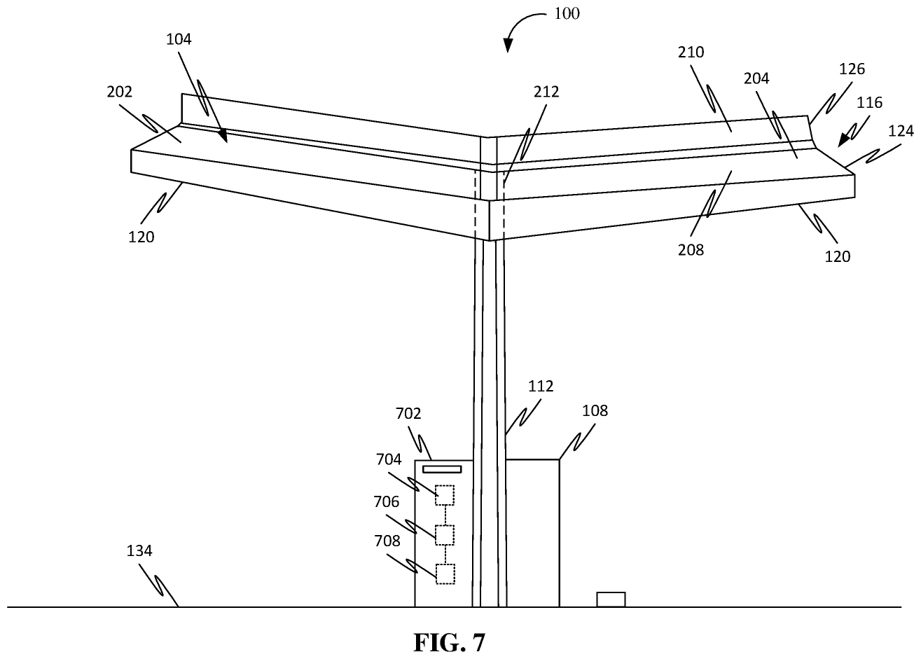

In further embodiments, the charging apparatus 100 may include at least one kiosk 702, as shown in FIG. 7, installed on the charging structure 102. Further, the at least one kiosk may be an interactive kiosk. Further, the interactive kiosk may be a computing device. Further, each of the at least one kiosk 702 may include at least one input device 704, a processing device 706, and a communication device 708, as shown in FIG. 7. Further, the at least one input device 704 may be configured for generating at least one service request associated with at least one service. Further, the at least one input device 704 receives at least one input from at least one user for the generating of the at least one service request. Further, the at least one service may include a purchase and delivery service, an ordering and delivery service, etc. Further, the processing device 706 may be communicatively coupled with the at least one input device 704. Further, the processing device 706 may be configured for analyzing the at least one service request. Further, the processing device 706 may be configured for identifying at least one service provider from a plurality of service providers based on the analyzing. Further, the at least one service provider may include an individual, a facility, etc. that provides the at least one service. Further, the processing device 706 may be configured for generating at least one order of the at least one service for the at least one service provider based on the identifying. Further, the communication device 708 may be communicatively coupled with the processing device 706. Further, the communication device 708 may be configured for transmitting the at least one order to at least one service provider device associated with the at least one service provider. Further, the at least one service provider device may include a client device, a computing device, a server, etc.

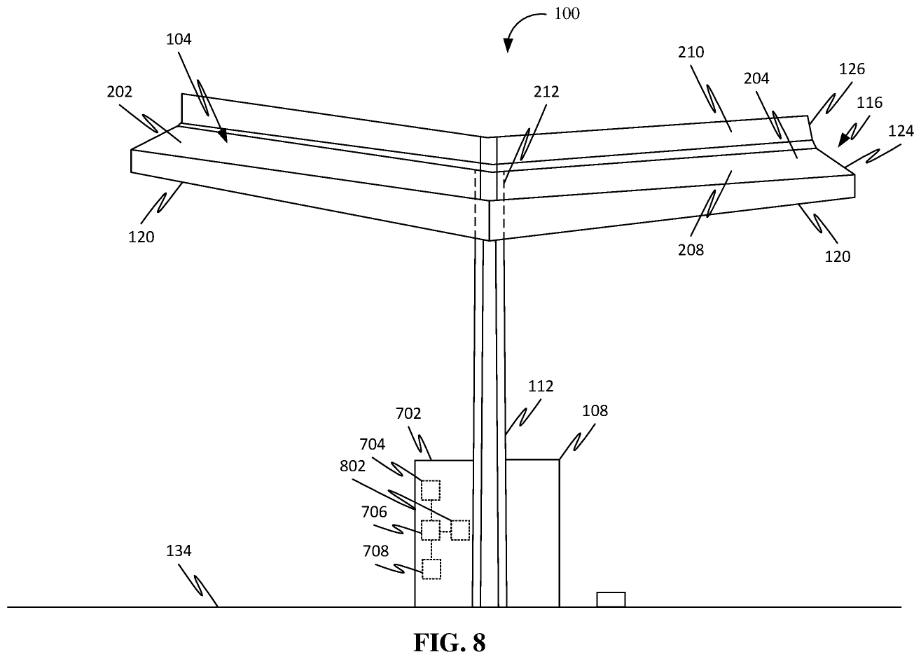

Further, in an embodiment, each of the at least one kiosk 702 may include a storage device 802, as shown in FIG. 8, communicatively coupled with the processing device 706. Further, the storage device 802 may be configured for retrieving a plurality of service provider information associated with the plurality of service providers. Further, the plurality of service provider information may include services offered by the plurality of service providers, locations of the plurality of service providers, credentials of the plurality of service providers, etc. Further, the storage device 802 may be configured for retrieving the location of the charging apparatus 100. Further, the processing device 706 may be configured for analyzing the plurality of service provider information and the location. Further, the processing device 706 may be configured for determining at least one value for at least one parameter associated with a suitability of each of the plurality of service providers based on the analyzing of the plurality of service provider information and the location. Further, the at least one parameter associated with the suitability may include a proximity, a servicing time, etc. Further, the identifying of the at least one service provider from the plurality of service providers may be based on the determining.

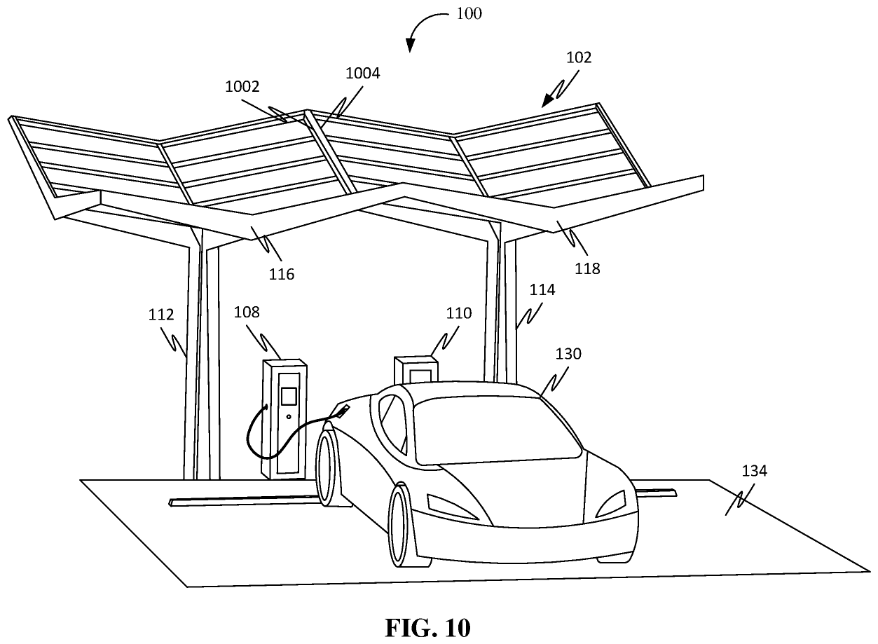

Further, in some embodiments, the at least one roof structure 116-118 may include a first roof structure 116 and a second roof structure 118. Further, a first peripheral side 1002 of the first roof structure 116 may be attached to a second peripheral side 1004 of the second roof structure 118, as shown in FIG. 10. Further, the at least one leg 112-114 may include a first leg 112 and second leg 114. Further, the first roof structure 116 may be supported on the first leg 112 and the second roof structure 118 may be supported on the second leg 114.

FIG. 2 is a right side view of the charging apparatus 100, in accordance with some embodiments.

FIG. 3 is a right side view of the charging apparatus 100, in accordance with some embodiments.

FIG. 4 is a right side view of the charging apparatus 100, in accordance with some embodiments.

FIG. 5 is a right side view of the charging apparatus 100, in accordance with some embodiments.

FIG. 6 is a right side view of the charging apparatus 100, in accordance with some embodiments.

FIG. 7 is a right side view of the charging apparatus 100, in accordance with some embodiments.

FIG. 8 is a right side view of the charging apparatus 100, in accordance with some embodiments.

FIG. 9 is a left side view of the charging apparatus 100, in accordance with some embodiments.

FIG. 10 is a front perspective view of the charging apparatus 100 with the one or more electric vehicles 130, in accordance with some embodiments.

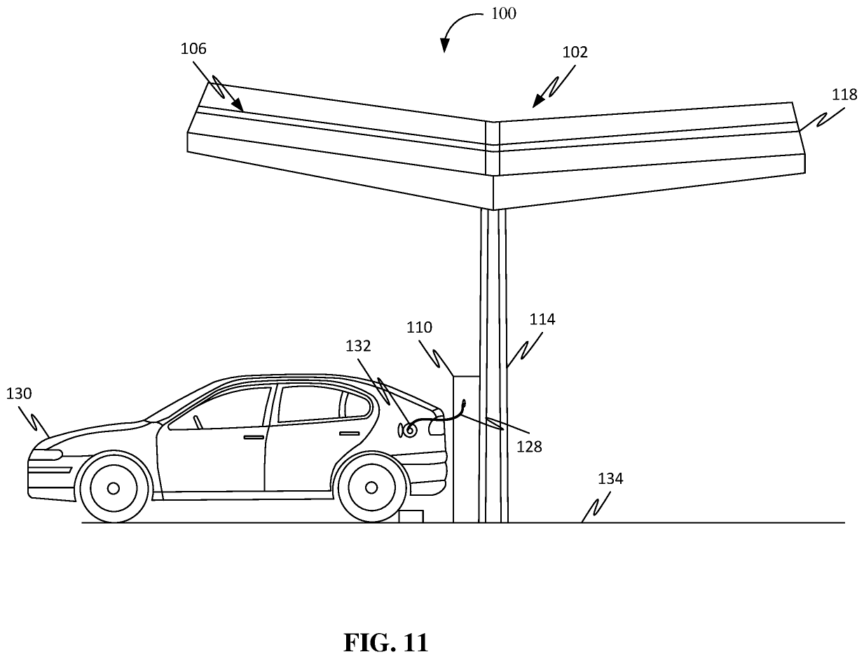

FIG. 11 is a left side view of the charging apparatus 100 with the one or more electric vehicles 130, in accordance with some embodiments.

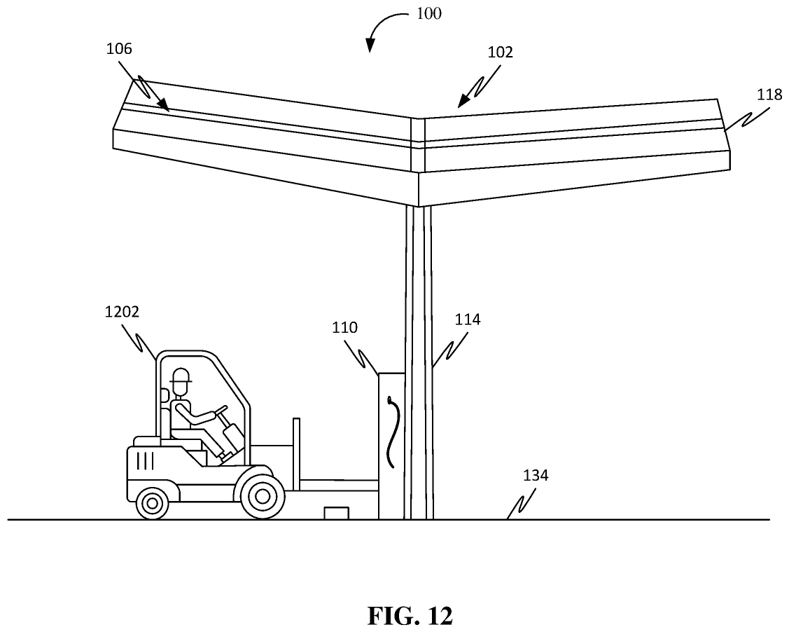

FIG. 12 is a left side view of the charging apparatus 100 with a moving vehicle 1202, in accordance with some embodiments. Further, the moving vehicle 1202 detachably connects with the charging apparatus 100 for moving the charging apparatus 100 for positioning the charging apparatus 100 on the surface 134 of the location.

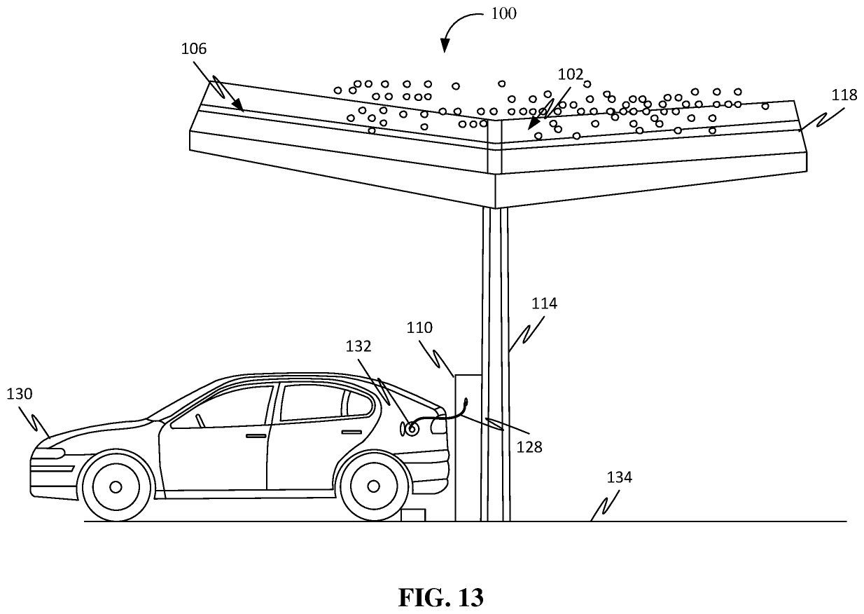

FIG. 13 is a left side view of the charging apparatus 100 with the one or more electric vehicles 130 and the at least one precipitation, in accordance with some embodiments. Further, the at least one precipitation may include rain, hail, snow, etc.

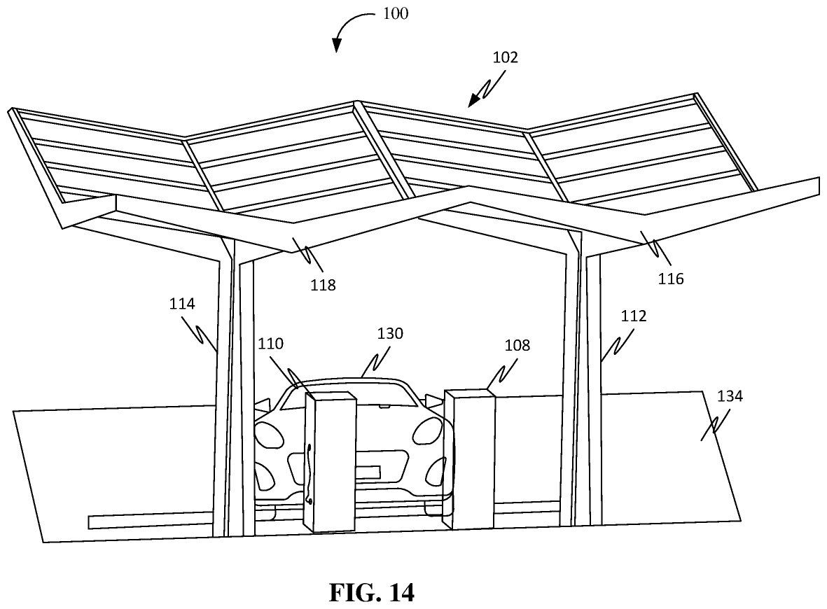

FIG. 14 is a rear perspective view of the charging apparatus 100 with the one or more electric vehicles 130, in accordance with some embodiments.

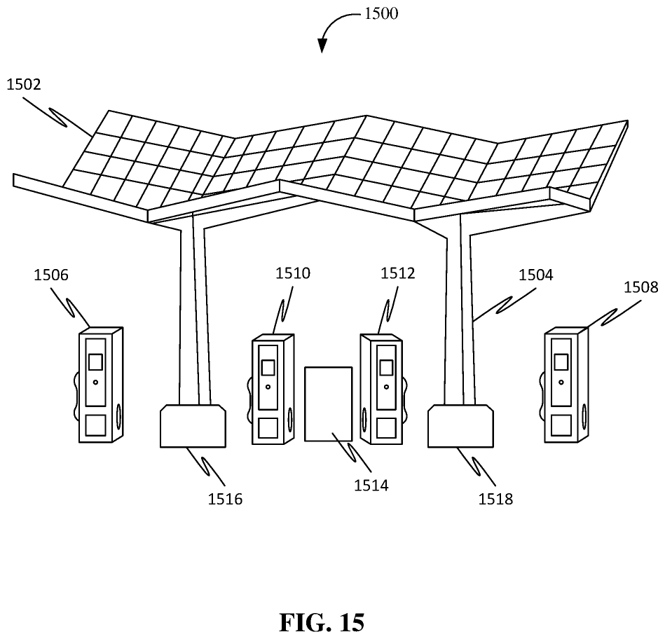

FIG. 15 is a front view of a charging apparatus 1500 for facilitating charging of electric vehicles, in accordance with some embodiments. Further, the charging apparatus 1500 may include a solar panel 1502, a support structure 1504, a plurality of charging stations 1506-1512, and an inverter 1514. Further, the support structure 1504 may be installed on at least one concrete block 1516-1518. Further, the plurality of charging stations 1506-1512 may include a plurality of fast charging DC stations 1506-1508 and a plurality of slow charging stations 1510-1512.

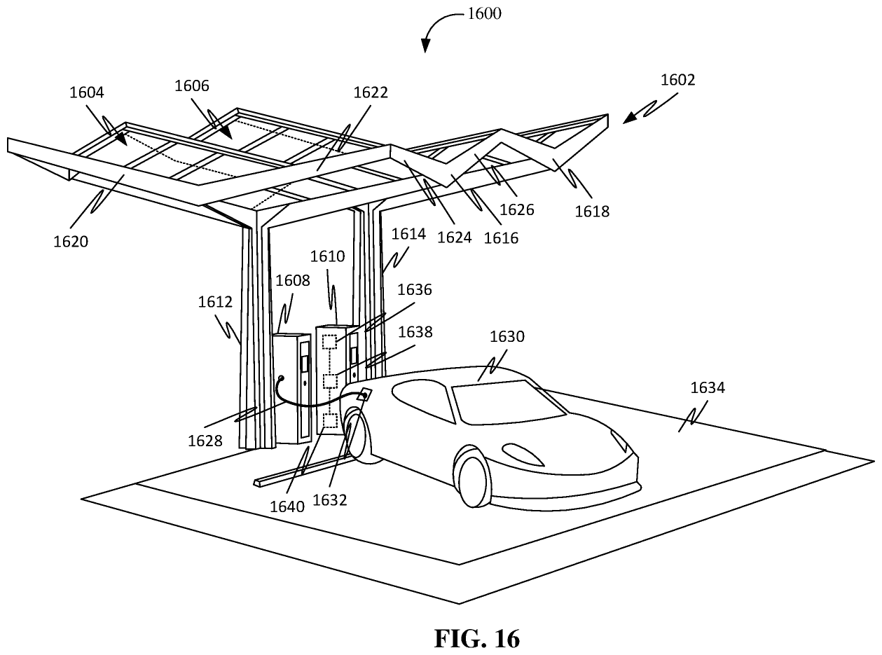

FIG. 16 is a perspective view of a charging apparatus 1600 for facilitating charging of electric vehicles with one or more electric vehicles 1630, in accordance with some embodiments. Accordingly, the charging apparatus 1600 may include a charging structure 1602, at least one solar panel 1604-1606, one or more charging stations 1608-1610, at least one first sensor 1636, a processing device 1638, and a communication device 1640.

Further, the charging structure 1602 may be movably positionable on a surface 1634 of a location. Further, the charging structure 1602 may include at least one leg 1612-1614 movably erected on the surface 1634 and at least one roof structure 1616-1618 supported on the at least one leg 1612-1614. Further, each of the at least one roof structure 1616-1618 corresponding to each of the at least one leg 1612-1614 may include two frame pairs 1620-1622. Further, a first frame pair 1620 of two frame pairs 1620-1622 laterally extends away from a first side of a top end of each of the at least one leg 1612-1614 and a second frame pair 1622 of the two frame pairs 1620-1622 laterally extends away from a second side opposite to the first side of the top end. Further, the first frame pair 1620 and the second frame pair 1622 may be upwardly inclined with respect to each of the at least one leg 1612-1614. Further, each of the first frame pair 1620 and the second frame pair 1622 may include a first frame 1624 and a second frame 1626 attached to the first frame 1624 forming an attachment axis. Further, the first frame 1624 and the second frame 1626 may be upwardly inclined with respect to the attachment axis.

Further, the at least one solar panel 1604-1606 may be mounted on the at least one roof structure 1616-1618. Further, the at least one solar panel 1604-1606 may include two solar panel pairs. Further, a first solar panel pair of the two solar panel pairs may be attached in the first frame pair 1620 and a second solar panel pair of the two solar panel pairs may be attached in the second frame pair 1622. Further, a first solar panel of each of the first solar panel pair and the second solar panel pair may be attached in the first frame 1624 and a second solar panel of each of the first solar panel pair and the second solar panel pair may be attached in the second frame 1626.

Further, the one or more charging stations 1608-1610 may be electrically coupled with at least one of the at least one solar panel 1604-1606 and an electrical grid. Further, the one or more charging stations 1608-1610 may be configured for receiving electrical energy from at least one of the at least one solar panel 1604-1606 and the electrical grid. Further, the one or more charging stations 1608-1610 may be configured for charging the one or more electric vehicles 1630 using one or more connectors 1628 based on the receiving of the electrical energy. Further, the one or more connectors 1628 electrically connects the one or more charging stations 1608-1610 to one or more charging ports 1632 of the one or more electric vehicles 1630.

Further, the at least one first sensor 1636 may be configured for generating at least one first sensor data based on detecting at least one parameter associated with the receiving of the electrical energy.

Further, the processing device 1638 may be communicatively coupled with the at least one first sensor 1636. Further, the processing device 1638 may be configured for analyzing the at least one first sensor data. Further, the processing device 1638 may be configured for generating an energy generation report associated with the receiving of the electrical energy based on the analyzing.

Further, the communication device 1640 may be communicatively coupled with the processing device 1638. Further, the communication device 1640 may be configured for transmitting the energy generation report to at least one device

Further, in some embodiments, the mounting of the at least one solar panel 1604-1606 on the at least one roof structure 1616-1618 defines a recessed area on a top side of the at least one roof structure 1616-1618. Further, each of the at least one leg 1612-1614 may include a hollow interior, a top opening disposed on the top end, and a bottom opening disposed on a bottom end of each of the at least one leg 1612-1614. Further, the top opening and the bottom opening may be fluidly coupled through the hollow interior. Further, the recessed area collects at least one precipitation falling on the top side of the at least one roof structure 1616-1618 and removes the at least one precipitation through the hollow interior based on transferring the at least one precipitation to the hollow interior from the top opening and exiting the at least one precipitation from the hollow interior through the bottom opening.

Further, in some embodiments, the at least one roof structure 1616-1618 may be detachably supported on the at least one leg 1612-1614.

Further, in some embodiments, the at least one solar panel 1604-1606 may include a bifacial solar panel.

Further, in some embodiments, the one or more charging stations 1608-1610 may be associated with one or more charging rates. Further, the charging of the one or more electric vehicles 1630 using the one or more connectors 1628 may include charging the one or more electric vehicles 1630 with the one or more charging rates using the one or more connectors 1628 based on the receiving of the electrical energy. Further, the one or more charging rates may include a first charging rate associated with a first charging station of the one or more charging stations 1608-1610 and a second charging rate associated with a second charging station of the one or more charging stations 1608-1610. Further, the first charging rate may be higher than the second charging rate.

Further, in some embodiments, each of the first solar panel and the second solar panel may be associated with at least one orientation based on the upwardly inclining of the first frame 1624 and the second frame 1626 with respect to the attachment axis and the upwardly inclining of the first frame pair 1620 and the second frame pair 1622 with respect to each of the at least one leg 1612-1614. Further, the at least one solar panel 1604-1606 generates the electrical energy with an efficiency based on the at least one orientation of each of the first solar panel and the second solar panel.

In further embodiments, the charging apparatus 1600 may include at least one second sensor. Further, the at least one second sensor may be configured for generating at least one second sensor data based on detecting at least one charging parameter associated with the charging of the one or more electric vehicles 1630. Further, the processing device 1638 may be configured for analyzing the at least one second sensor data. Further, the processing device 1638 may be configured for generating a charging report associated with the charging of the one or more electric vehicles 1630 based on the analyzing of the at least one second sensor data. Further, the communication device 1640 may be configured for transmitting the charging report to the at least one device.

Further, in an embodiment, the communication device 1640 may be configured for receiving at least one of a plurality of energy generation reports and a plurality of charging reports associated with a plurality of charging apparatuses from the at least one device. Further, the plurality of charging apparatuses may be located in a plurality of locations. Further, the processing device 1638 may be configured for analyzing at least one of the plurality of energy generation reports and the plurality of charging reports. Further, the processing device 1638 may be configured for determining a viability of the charging apparatus 1600 in the location based on the analyzing of at least one of the plurality of energy generation reports and the plurality of charging reports. Further, the processing device 1638 may be configured for generating a recommendation for the charging apparatus 1600 based on the determining. Further, the communication device 1640 may be configured for transmitting the recommendation to the at least one device.

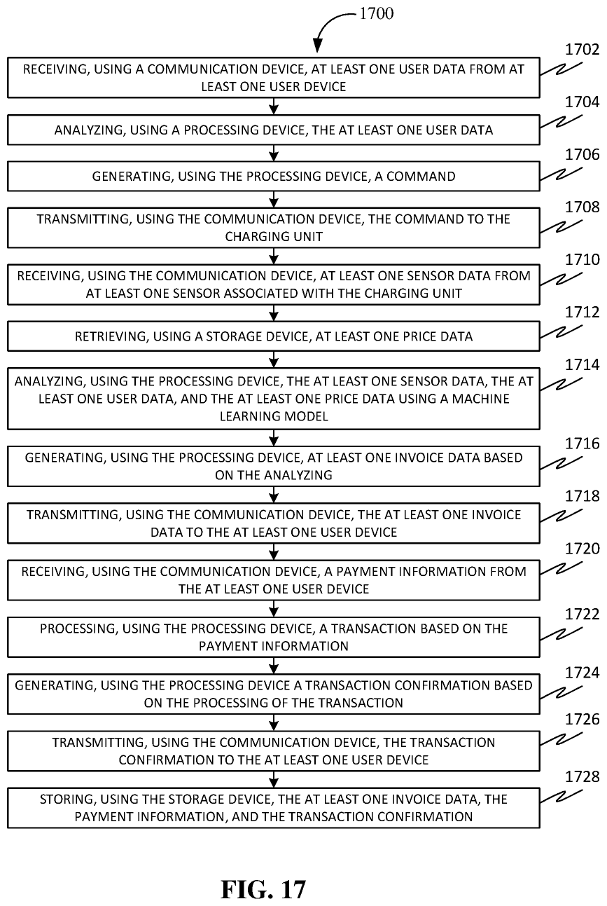

FIG. 17 is a flowchart of a method 1700 for facilitating charging of at least one electric vehicle (EV) using a charging unit, in accordance with some embodiments.

Further, the method 1700 may include a step 1702 of receiving, using a communication device, at least one user data from at least one user device. Further, the at least one user device may be associated with a user. Further, the at least one user data may include details of the user and the at least one EV associated with the user. Further, the at least one user data may include units of electricity required by the user.

Further, the method 1700 may include a step 1704 of analyzing, using a processing device, the at least one user data.

Further, the method 1700 may include a step 1706 of generating, using the processing device, a command. Further, the command may be generated for initiating a charging process for charging the at least one EV.

Further, the method 1700 may include a step 1708 of transmitting, using the communication device, the command to the charging unit. Further, the command may activate the charging unit for the charging process.

Further, the method 1700 may include a step 1710 of receiving, using the communication device, at least one sensor data from at least one sensor associated with the charging unit. Further, the at least one sensor data may include an instantaneous charging status, time taken for charging, time left for completing required charging, etc.

Further, the method 1700 may include a step 1712 of retrieving, using a storage device, at least one price data. Further, the at least one price data may include at least one price associated with charging the at least one EV at the charging unit.

Further, the method 1700 may include a step 1714 of analyzing, using the processing device, the at least one sensor data, the at least one user data, and the at least one price data using a machine learning model.

Further, the method 1700 may include a step 1716 of generating, using the processing device, at least one invoice data based on the analyzing. Further, the at least one invoice data may include an amount of money to be paid by the user for charging the at least one EV.

Further, the method 1700 may include a step 1718 of transmitting, using the communication device, the at least one invoice data to the at least one user device.

Further, the method 1700 may include a step 1720 of receiving, using the communication device, a payment information from the at least one user device. Further, the payment information may include an amount of money paid by the user.

Further, the method 1700 may include a step 1722 of processing, using the processing device, a transaction based on the payment information.

Further, the method 1700 may include a step 1724 of generating, using the processing device a transaction confirmation based on the processing of the transaction.

Further, the method 1700 may include a step 1726 of transmitting, using the communication device, the transaction confirmation to the at least one user device.

Further, the method 1700 may include a step 1728 of storing, using the storage device, the at least one invoice data, the payment information, and the transaction confirmation.

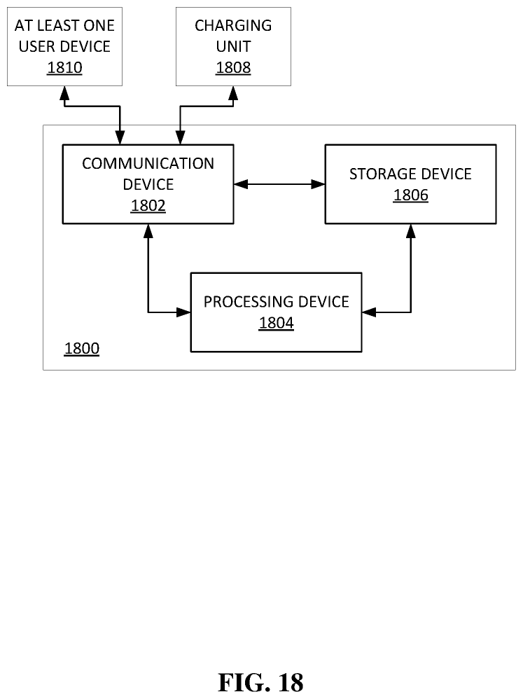

FIG. 18 is a block diagram of a system 1800 for facilitating charging of at least one electric vehicle (EV) using a charging unit 1808, in accordance with some embodiments. Accordingly, the system 1800 may include a processing device 1804, a communication device 1802, and a storage device 1806. Further, the communication device 1802 may be communicatively coupled with the processing device 1804. Further, the communication device 1802 may be communicatively coupled with the storage device 1806. Further, the storage device 1806 may be communicatively coupled with the processing device 1804.

Further, the communication device 1802 may be configured for receiving at least one user data from at least one user device 1810. Further, the at least one user device 1810 may be associated with a user. Further, the at least one user data may include details of the user and the at least one EV associated with the user. Further, the at least one user data may include units of electricity required by the user. Further, the communication device 1802 may be configured for transmitting a command to the charging unit 1808. Further, the command may activate the charging unit 1808 for the charging process. Further, the communication device 1802 may be configured for receiving at least one sensor data from at least one sensor associated with the charging unit 1808. Further, the at least one sensor data may include an instantaneous charging status, time taken for charging, time left for completing required charging, etc. Further, the communication device 1802 may be configured for transmitting at least one invoice data to the at least one user device 1810. Further, the communication device 1802 may be configured for receiving a payment information from the at least one user device 1810. Further, the payment information may include an amount of money paid by the user. Further, the communication device 1802 may be configured for transmitting a transaction confirmation to the at least one user device 1810.

Further, the processing device 1804 may be configured for analyzing the at least one user data. Further, the processing device 1804 may be configured for generating the command. Further, the command may be generated for initiating a charging process for charging the at least one EV. Further, the processing device 1804 may be configured for analyzing the at least one sensor data, the at least one user data, and at least one price data using a machine learning model. Further, the processing device 1804 may be configured for generating the at least one invoice data based on the analyzing. Further, the at least one invoice data may include an amount of money to be paid by the user for charging the at least one EV.

Further, the processing device 1804 may be configured for processing a transaction based on the payment information. Further, the processing device 1804 may be configured for generating the transaction confirmation based on the processing of the transaction.

Further, the storage device 1806 may be configured for retrieving the at least one price data. Further, the at least one price data may include at least one price associated with charging the at least one EV at the charging unit 1808. Further, the storage device 1806 may be configured for storing the at least one invoice data, the payment information, and the transaction confirmation.

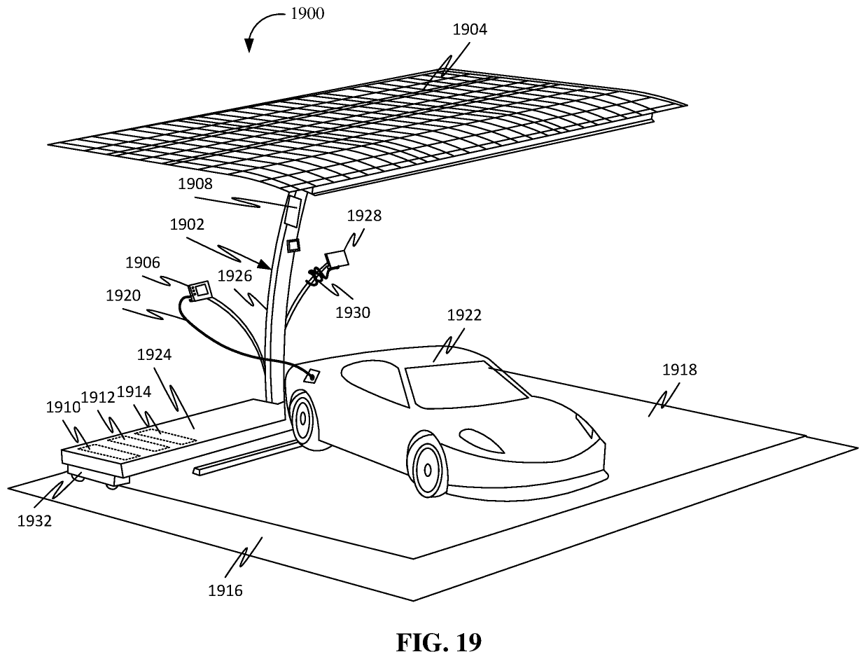

FIG. 19 is a perspective view of a charging apparatus 1900 with at least one electric vehicle 1922, in accordance with some embodiments. Accordingly, the charging apparatus 1900 may include a charging structure 1902, at least one solar panel 1904, at least one charging station (1906 and 1928), at least one sensor 1910, at least one environment sensor 1912, a processing device 1914, and at least one actuator 1908. Further, the charging apparatus 1900 may be a charging unit.

Further, the charging structure 1902 may be movably positionable on a surface 1916 of at least one location. Further, the charging structure 1902 delimits a charging area 1918 on the surface 1916 based on positioning of the charging structure 1902 on the surface 1916. Further, the at least one location may include a parking lot, a town hall, a gas station, etc.

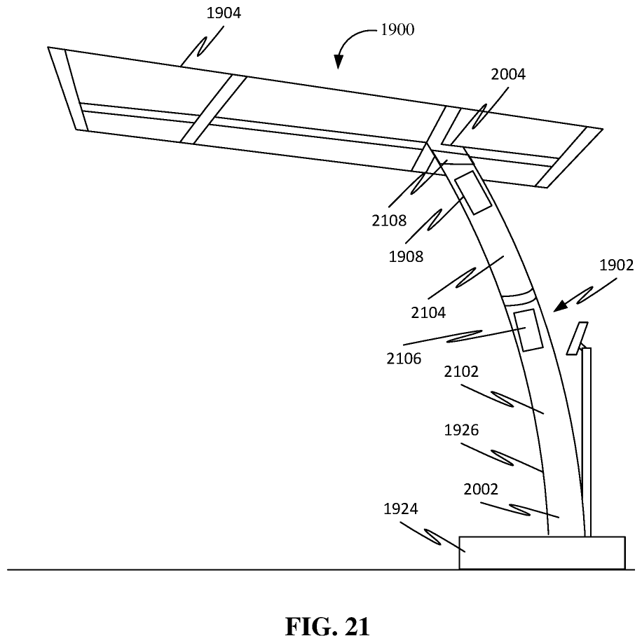

Further, the at least one solar panel 1904 may be movably mounted on the charging structure 1902 for extending over at least a part of the charging area 1918. Further, the at least one solar panel 1904 may be configured to be transitioned between a plurality of orientations in relation to the charging area 1918. Further, the at least one solar panel 1904 may be a bifacial solar panel. Further, movably mounting may include pivotally attaching the at least one solar panel 1904 to the charging structure using at least one joint 2108, as shown in FIG. 21. Further, the at least one joint 2108 allows pivoting of the at least one solar panel 1904 about one or more axes of the at least one joint 2108 between a plurality of positions corresponding to the plurality of orientations. Further, the at least one joint 2108 may include a ball joint, a hinge joint, etc.

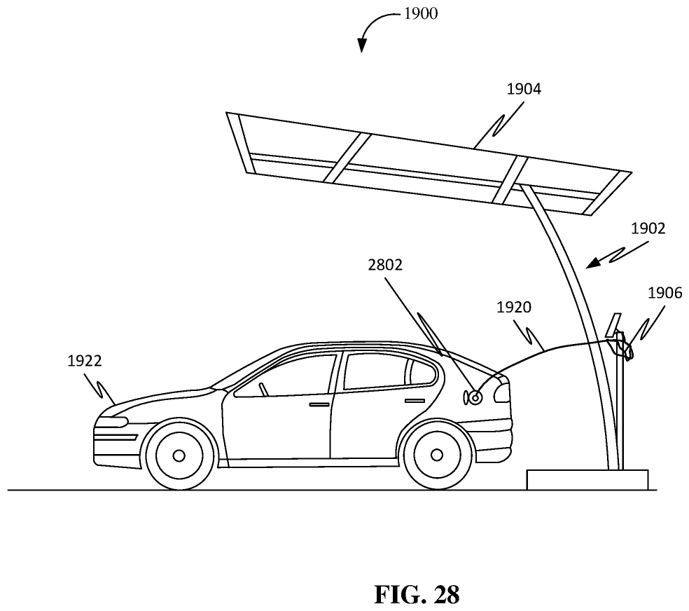

Further, the at least one charging device (1906 and 1928) may be electrically coupled with the at least one solar panel 1904. Further, the at least one charging device (1906 and 1928) may be configured for charging the at least one electric vehicle 1922 present in the charging area 1918 using at least one connector (1920 and 1930) based on receiving electrical energy from the at least one solar panel 1904. Further, the at least one solar panel 1904 produces the electrical energy based on capturing solar energy. Further, the electrical energy may be DC electrical energy. Further, the at least one connector (1920 and 1930) electrically couples the at least one charging device (1906 and 1928) to the at least one electric vehicle 1922. Further, the at least one connector (1920 and 1930) may be a plugin wire. Further, the at least one connector (1920 and 1930) may include a charging plug 2802, as shown in FIG. 28. Further, the at least one charging device (1906 and 1928) may be a charger. Further, the at least one charging device (1906 and 1928) may be an electrical and/or electronic device that stores the electrical energy in a battery by running one or more amounts of current through the battery at one or more voltage levels. Further, the at least one charging device (1906 and 1928) may be a charging station. Further, the at least one charging device (1906 and 1928) may include a rectifier circuit, a power circuit, a ripple monitoring, a control circuit, a regulator circuit, and a fault detection circuit. Further, the at least one charging device (1906 and 1928) may be at least one of an electric and/or electronic circuitry that electrically connects the at least one solar panel 1904 to the at least one electric vehicle 1922 using the at least one connector (1920 and 1930) for allowing transfer of the electrical energy from the at least one solar panel 1904 to the at least one electric vehicle 1922.

Further, the at least one sensor 1910 may be configured for generating at least one sensor data based on detecting a position of the at least one electric vehicle 1922 in relation to the at least one solar panel 1904 after electrically coupling the at least one electric vehicle 1922 to the at least one charging device (1906 and 1928). Further, the at least one sensor 1910 may include an orientation sensor, a position sensor, a camera, an infrared (IR) camera, etc. Further, the at least one sensor data may include the position of the at least one electric vehicle 1922 in relation to the at least one solar panel 1904. Further, the electrically coupling may include inserting the charging plug 2802 into a charging socket of the at least one electric vehicle 1922. Further, the generating of the at least one sensor data may be based on detecting an orientation of the at least one electric vehicle 1922 in relation to the at least one solar panel 1904. Further, the at least one sensor data may include the orientation of the at least one electric vehicle 1922 in relation to the at least one solar panel 1904.

Further, the at least one environment sensor 1912 may be configured for generating at least one environment element data based on detecting at least one environment element associated with an environment of the charging apparatus 1900. Further, the at least one environment element may include sunlight, rain, snow, hail, wind, etc. Further, the at least one environment element data may include an inclination of the sunlight with respect to a plane parallel to the charging area 1918, an inclination of the rain with respect to a plane parallel to the charging area 1918, an inclination of the snow falling with respect to a plane parallel to the charging area 1918, an inclination of the hail falling with respect to a plane parallel to the charging area 1918, an inclination of the wind blowing with respect to a plane parallel to the charging area 1918, etc. Further, the at least one environment sensor 1912 may include a wind direction sensor, a rain sensor, a snow sensor, a sun sensor, etc.

Further, the processing device 1914 may be communicatively coupled with the at least one sensor 1910 and the at least one environment sensor 1912. Further, the processing device 1914 may be configured for analyzing the at least one sensor data and the at least one environment element data. Further, the processing device 1914 may be configured for determining a modified orientation from the plurality of orientations for the at least one solar panel 1904 based on the analyzing. Further, the at least one solar panel 1904 in the modified orientation protects the at least one electric vehicle 1922 from the at least one environment element. Further, protecting the at least one electric vehicle 1922 from the at least one environment element may include shading the at least one electric vehicle 1922 from the at least one environment element, intercepting the at least one environment element intended to strike the at least one electric vehicle 1922, etc. Further, the processing device 1914 may be configured for generating at least one command for the at least one solar panel 1904 based on the determining.

Further, the at least one actuator 1908 may be operatably coupled with the at least one solar panel 1904. Further, the at least one actuator 1908 may be communicatively coupled with the processing device 1914. Further, the at least one actuator 1908 may be configured for transitioning the at least one solar panel 1904 from a current orientation of the plurality of orientations of the at least one solar panel 1904 to the modified orientation based on the at least one command. Further, the at least one actuator 1908 may include an electrically operated solenoid, an electrically operated linear motor, an electric motor, etc. Further, the at least one actuator 1908 may rotate the at least one solar panel 1904 about the one or more axes for the transitioning of the at least one solar panel 1904 from the current orientation to the modified orientation.

Further, in some embodiments, the charging structure 1902 may include a base 1924 and at least one leg 1926. Further, the base 1924 may include at least one movement mechanism 1932 for allowing at least one movement to the charging apparatus 1900 on the surface 1916. Further, the at least one movement mechanism 1932 may include at least one wheel rotatable about an axis, at least one ball rotatable about a plurality of axes of the at least one ball, etc. Further, the at least one movement mechanism 1932 may be an electrically actuated mechanism that rotates the at least one ball, the at least one wheel, etc. for the allowing of the at least one movement.

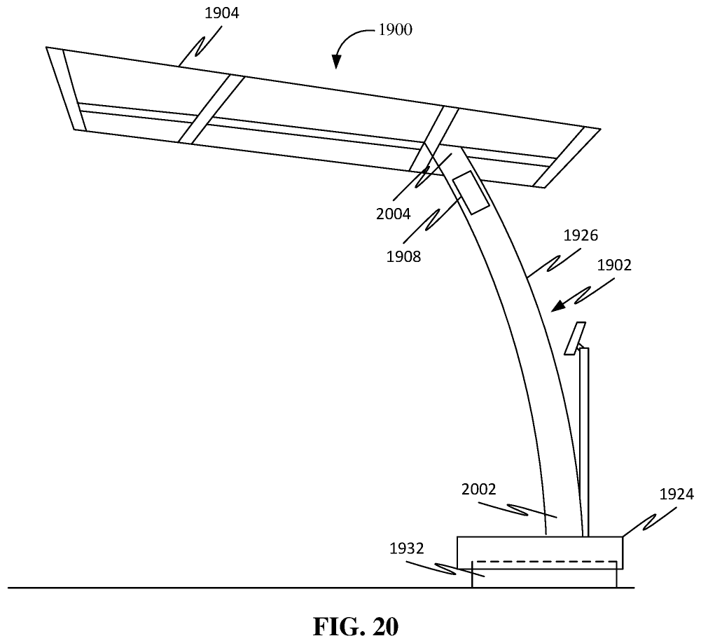

Further, in an embodiment, the at least one leg 1926 may include a first end 2002 and a second end 2004, as shown in FIG. 20. Further, the first end 2002 may be attached to the base 1924 and the second end 2004 extends away from the base 1924. Further, the at least one solar panel 1904 may be movably attached to the second end 2004 of the at least one leg 1926 for movably mounting the at least one solar panel 1904 on the charging structure 1902. Further, the at least one leg 1926 may be an elongated body extending between the first end 2002 and the second end 2004.

Further, in an embodiment, the at least one leg 1926 may include at least one main leg portion 2102 and at least one extendable leg portion 2104, as shown in FIG. 21, extendably disposed in the at least one main leg portion 2102. Further, the at least one main leg portion 2102 may include the first end 2002 and the at least one extendable leg portion 2104 may include the second end 2004. Further, the at least one extendable leg portion 2104 retractably extends between a plurality of leg positions in relation to the at least one main leg portion 2102 for transitioning the at least one solar panel 1904 between a plurality of heights in relation to the charging area 1918.

In further embodiments, the charging apparatus 1900 may include at least one first actuator 2106, as shown in FIG. 21. Further, the at least one first actuator 2106 may include an electrically operated solenoid, an electrically operated linear motor, an electric motor, etc. Further, the at least one first actuator 2106 may be operatably coupled with the at least one main leg portion 2102 and the at least one extendable leg portion 2104. Further, the at least one first actuator 2106 may be communicatively coupled with the processing device 1914. Further, the generating of the at least one sensor data may be further based on detecting a height of the at least one electric vehicle 1922. Further, the processing device 1914 may be further configured for determining a modified height from a plurality of heights for the at least one solar panel 1904 based on the analyzing of the at least one sensor data. Further, the at least one solar panel 1904 in the modified height protects the at least one electric vehicle 1922 from the at least one environment element. Further, the processing device 1914 may be further configured for determining a leg position from the plurality of leg positions based on the modified height. Further, the processing device 1914 may be further configured for generating at least one first command for the at least one solar panel 1904 based on the determining of the leg position. Further, the at least one first actuator 2106 may be configured for retractably extending the at least one extendable leg portion 2104 to the leg position in relation to the at least one main leg portion 2102 based on the at least one first command.

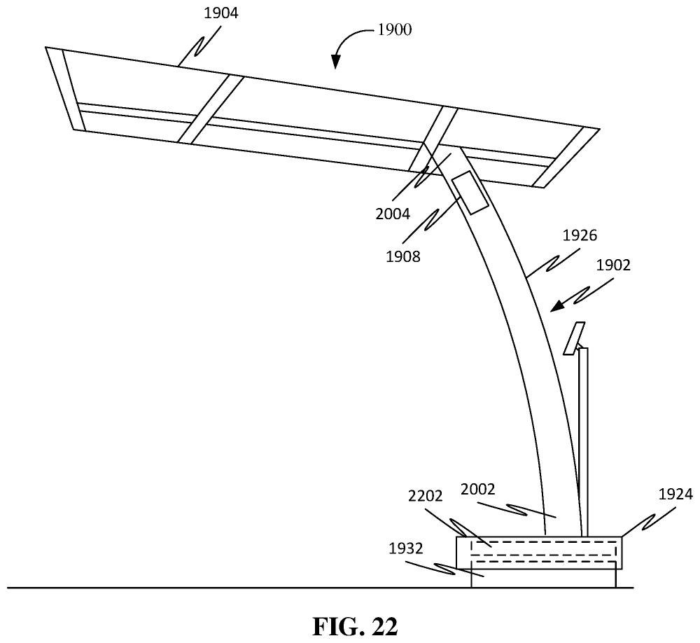

In further embodiments, the charging apparatus 1900 may include at least one first sensor 2202, as shown in FIG. 22. Further, the at least one first sensor 2202 may include a location sensor, a position sensor, a camera, etc. Further, the at least one first sensor 2202 may be communicatively coupled with the processing device 1914. Further, the at least one first sensor 2202 may be configured for generating at least one first sensor data based on detecting at least one location characteristic of the at least one location. Further, the at least one first sensor data may include the at least one location characteristic. Further, the at least one location characteristic may include a size of the at least one location, at least one of an entrance and an exit to the at least one location, a boundary of the at least one location, a shape of the at least one location, a presence of immovable objects on the at least one location, etc. Further, the processing device 1914 may be configured for analyzing the at least one first sensor data. Further, the analyzing of the at least one first sensor data may include analyzing the at least one first sensor data using at least one machine learning model. Further, the at least one machine learning model may be trained for identifying an optimal location on the surface 1916 of the at least one location for positioning the charging structure 1902. Further, the positioning of the charging structure 1902 on the optimal location allows the at least one electric vehicle 1922 entering the at least one location through the entrance to easily maneuver towards the charging area 1918. Further, the positioning of the charging structure 1902 on the optimal location allows the at least one electric vehicle 1922 to maneuver away from the charging area 1918 for exiting the at least one location through the exit. Further, the processing device 1914 may be configured for determining the at least one location on the surface 1916 based on the analyzing of the at least one first sensor data. Further, the at least one location may be the optimal location. Further, the processing device 1914 may be configured for generating at least one second command for the charging structure 1902 based on the determining of the at least one location. Further, the at least one movement mechanism 1932 may be communicatively coupled with the processing device 1914. Further, the at least one movement mechanism 1932 may be configured for moving the charging apparatus 1900 to the at least one location on the surface 1916 based on the at least one second command.

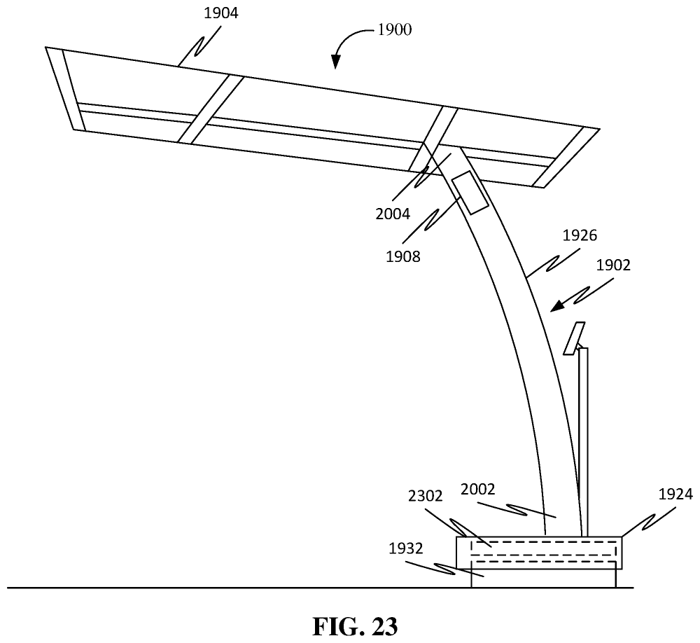

In further embodiments, the charging apparatus 1900 may include at least one second sensor 2302, as shown in FIG. 23. Further, the at least one second sensor 2302 may include a position sensor, a location sensor, a camera, a sound sensor, etc. Further, the at least one second sensor 2302 may be communicatively coupled with the processing device 1914. Further, the at least one second sensor 2302 may be configured for generating at least one second sensor data based on detecting a position of the at least one electric vehicle 1922 on the at least one location. Further, the at least one second sensor data may include the position of the at least one electric vehicle 1922 on the at least one location. Further, the processing device 1914 may be configured for analyzing the at least one second sensor data. Further, the processing device 1914 may be configured for determining the at least one location on the surface 1916 based on the analyzing of the at least one second sensor data. Further, the processing device 1914 may be configured for generating at least one third command for the charging structure 1902 based on the determining of the at least one location. Further, the at least one movement mechanism 1932 may be communicatively coupled with the processing device 1914. Further, the at least one movement mechanism 1932 may be configured for moving the charging apparatus 1900 to the at least one location on the surface 1916 based on the at least one third command.

Further, in some embodiments, the at least one solar panel 1904 in the current orientation may be tilted away from the charging area 1918 with at least one tilt. Further, the at least one environment element may include snow. Further, the at least one solar panel 1904 tilted with the at least one tilt prevents the snow falling on the at least one solar panel 1904 from falling on the charging area 1918.

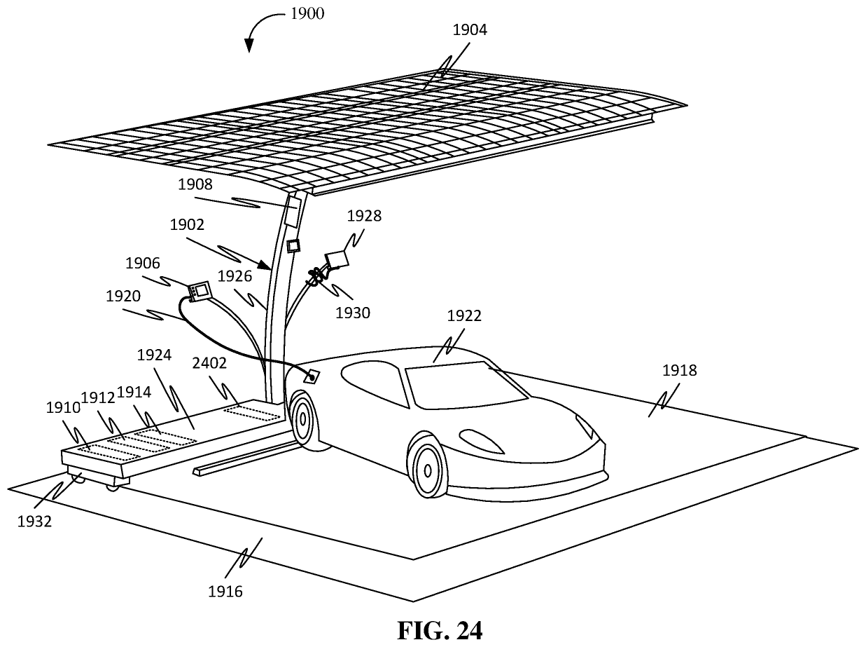

In further embodiments, the charging apparatus 1900 may include at least one battery 2402, as shown in FIG. 24. Further, the at least one battery 2402 may be electrically coupled with the at least one charging device (1906 and 1928). Further, the at least one charging device (1906 and 1928) may be configured for transferring the electrical energy received by the at least one charging device (1906 and 1928) to the at least one battery 2402 based on a disconnected state of the at least one charging device (1906 and 1928). Further, the at least one connector (1920 and 1930) may be not electrically coupled with the at least one electric vehicle 1922 in the disconnected state. Further, the charging plug 2802 may be removed from the charging socket of the at least one electric vehicle 1922 in the disconnected state. Further, the at least one charging device (1906 and 1928) does not transfer the electrical energy to the at least one battery 2402 in a connected state of the at least one charging device (1906 and 1928). Further, the at least one connector (1920 and 1930) may be electrically coupled with the at least one electric vehicle 1922 in the connected state. Further, the charging plug 2802 may be inserted in the charging socket of the at least one electric vehicle 1922 in the connected state.

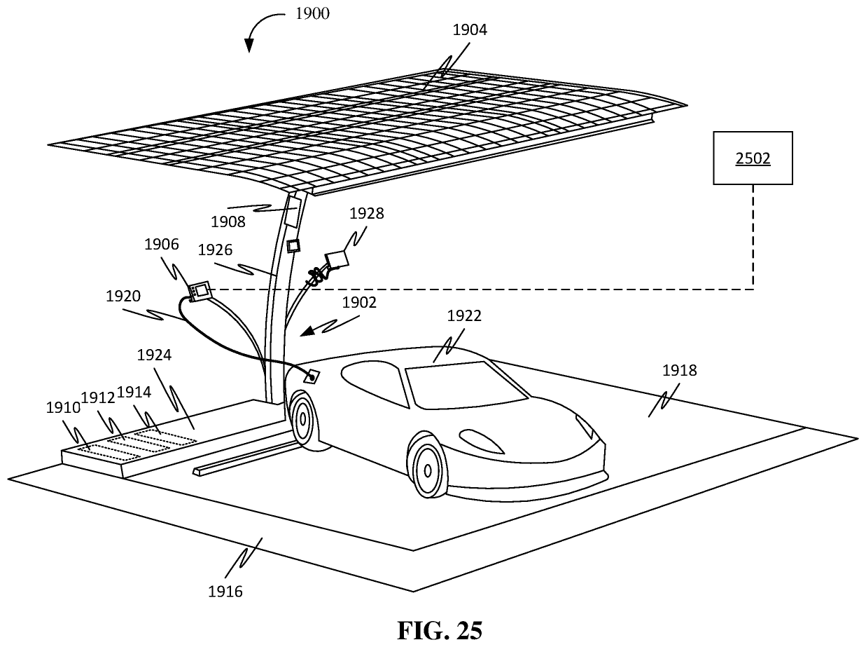

Further, in some embodiments, the at least one charging device (1906 and 1928) may be electrically coupled with an electrical grid 2502, as shown in FIG. 25. Further, the charging of the at least one electric vehicle 1922 may be further based on receiving electrical energy from the electrical grid 2502. Further, the at least one charging device (1906 and 1928) rectifies the electrical energy.

Further, in some embodiments, the at least one charging device (1906 and 1928) may include at least one first charging device 1906 and at least one second charging device 1928. Further, the charging of the at least one electric vehicle 1922 by the at least one first charging device 1906 may be associated with a first charging speed and the charging of the at least one electric vehicle 1922 by the at least one second charging device 1928 may be associated with a second charging speed. Further, the first charging speed may be greater than the second charging speed.

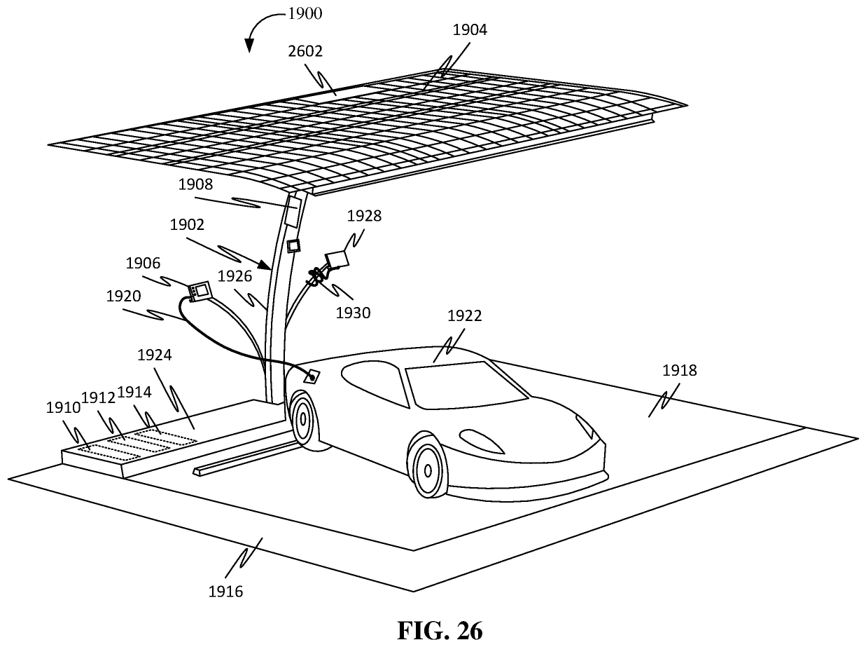

In further embodiments, the charging apparatus 1900 may include a solar tracking device 2602, as shown in FIG. 26. Further, the solar tracking device 2602 may be a sensor fro tracking the sun. Further, the solar tracking device 2602 may be communicatively coupled with the processing device 1914. Further, the at least one solar tracking device 2602 may be configured for generating at least one solar panel data based on detecting a position of the sun in the sky in relation to the at least one location. Further, the at least one solar panel data may include an orientation recommendation of the at least one solar panel 1904 with respect to the sun. Further, the processing device 1914 may be further configured for analyzing the at least one solar panel data. Further, the determining of the modified orientation of the at least one solar panel 1904 may be further based on the analyzing of the at least one solar panel data.

FIG. 20 is a left side view of the charging apparatus 1900, in accordance with some embodiments.

FIG. 21 is a left side view of the charging apparatus 1900, in accordance with some embodiments.

FIG. 22 is a left side view of the charging apparatus 1900, in accordance with some embodiments.

FIG. 23 is a left side view of the charging apparatus 1900, in accordance with some embodiments.

FIG. 24 is a perspective view of the charging apparatus 1900 with the at least one electric vehicle 1922, in accordance with some embodiments.

FIG. 25 is a perspective view of the charging apparatus 1900 with the at least one electric vehicle 1922, in accordance with some embodiments.

FIG. 26 is a perspective view of the charging apparatus 1900 with the at least one electric vehicle 1922, in accordance with some embodiments.

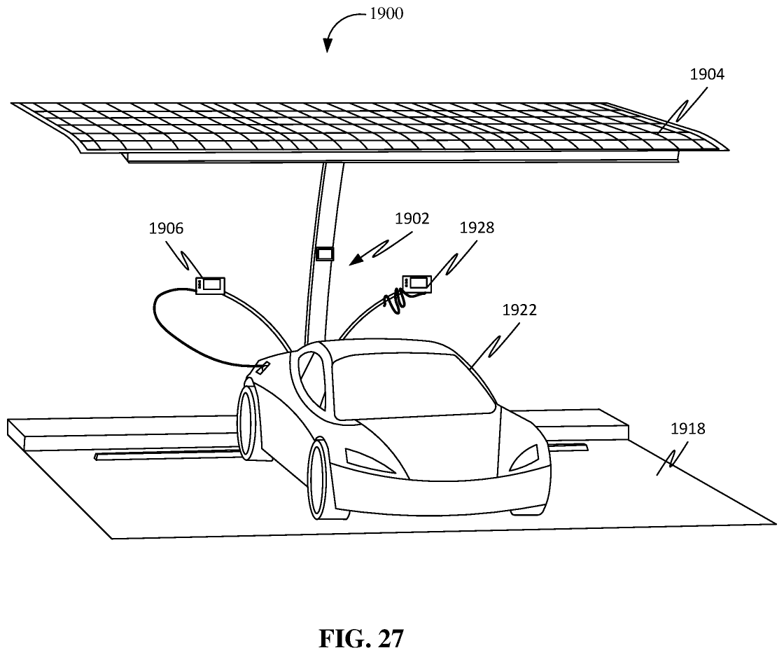

FIG. 27 is a front view of the charging apparatus 1900 with the at least one electric vehicle 1922, in accordance with some embodiments.

FIG. 28 is a left side view of the charging apparatus 1900 with the at least one electric vehicle 1922, in accordance with some embodiments.

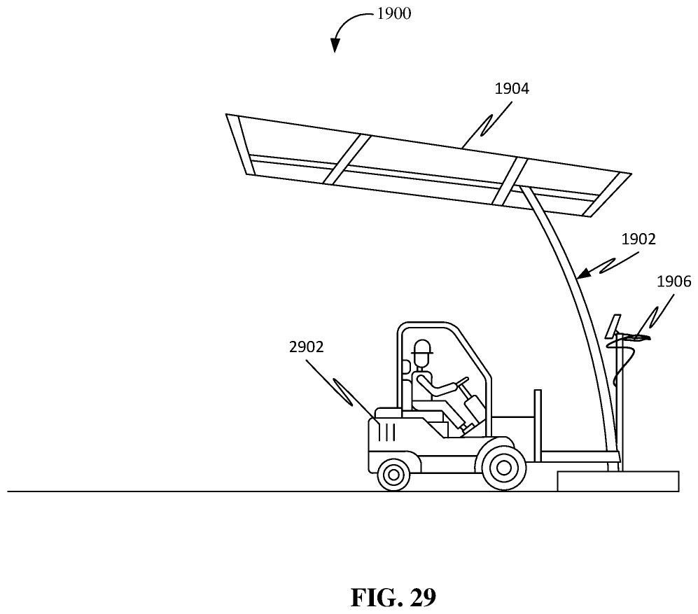

FIG. 29 is a left side view of the charging apparatus 1900 with a driving mechanism 2902, in accordance with some embodiments. Further, the driving mechanism 2902 may be used for moving the charging apparatus 1900.

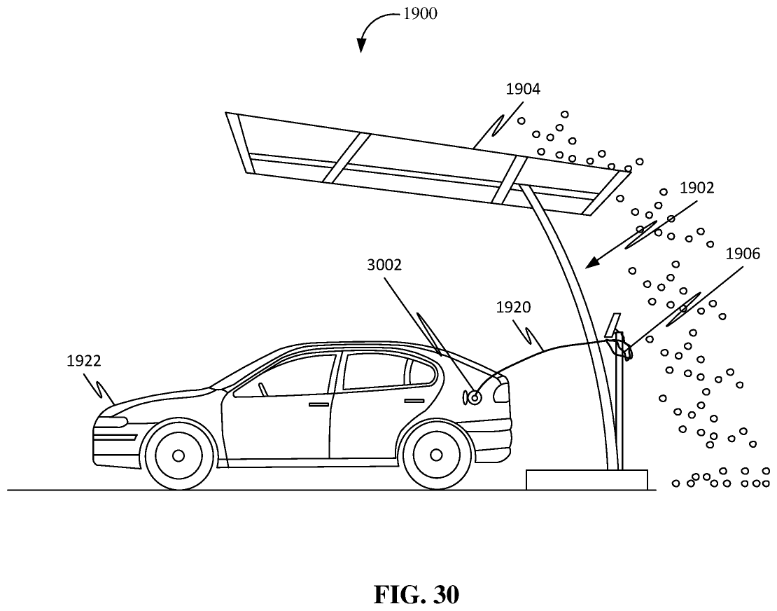

FIG. 30 is a left side view of the charging apparatus 1900 with the at least one electric vehicle 1922, in accordance with some embodiments. Further, the snow falling on the at least one solar panel 1904 falls away from the charging area 1918.

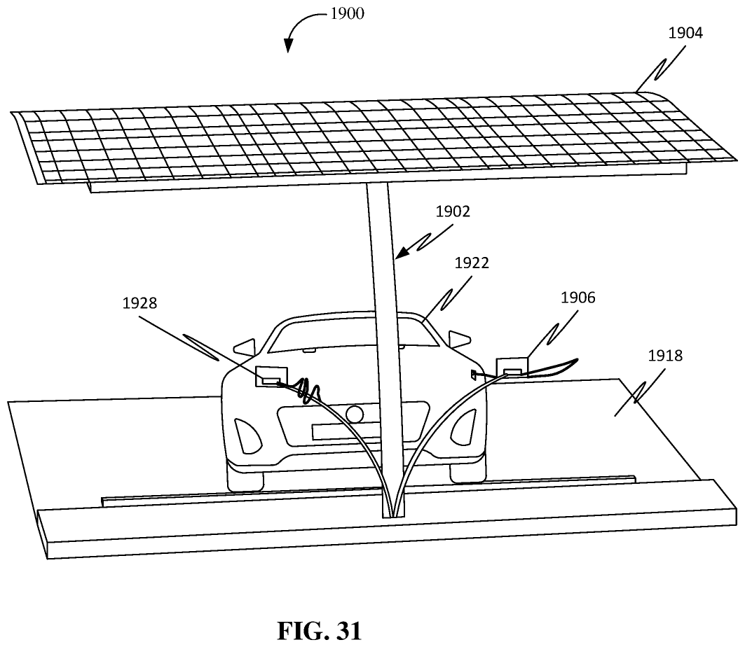

FIG. 31 is a rear view of the charging apparatus 1900 with the at least one electric vehicle 1922, in accordance with some embodiments.

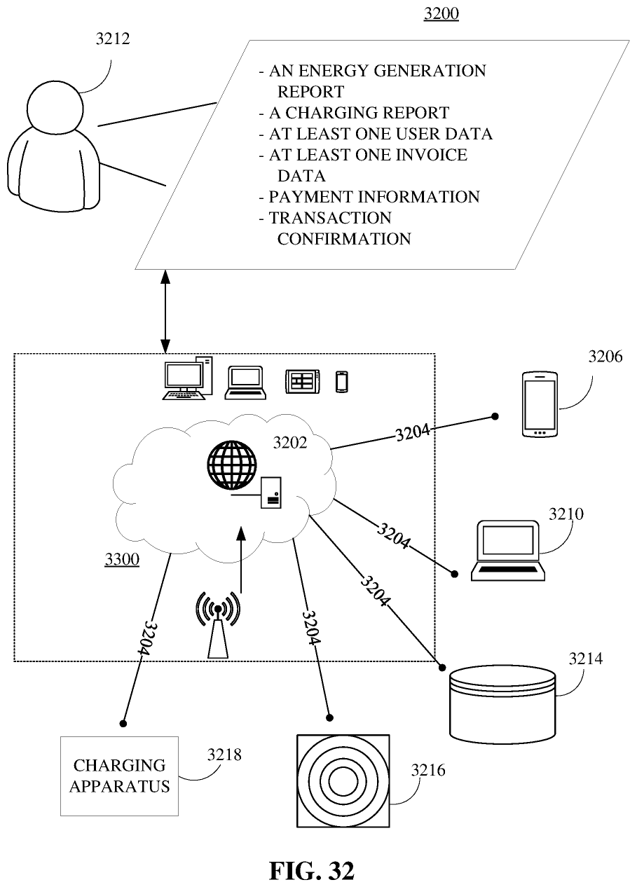

FIG. 32 is an illustration of an online platform 3200 consistent with various embodiments of the present disclosure. By way of non-limiting example, the online platform 3200 to facilitate charging of electric vehicles may be hosted on a centralized server 3202, such as, for example, a cloud computing service. The centralized server 3202 may communicate with other network entities, such as, for example, a mobile device 3206 (such as a smartphone, a laptop, a tablet computer, etc.), other electronic devices 3210 (such as desktop computers, server computers, etc.), databases 3214, sensors 3216, and a charging apparatus 3218 (such as the charging apparatus 100, the charging apparatus 1600, the charging apparatus 1900, etc.) over a communication network 3204, such as, but not limited to, the Internet. Further, users of the online platform 3200 may include relevant parties such as, but not limited to, operators, end-users, administrators, service providers, service consumers, and so on. Accordingly, in some instances, electronic devices operated by the one or more relevant parties may be in communication with the platform.

A user 3212, such as the one or more relevant parties, may access online platform 3200 through a web based software application or browser. The web based software application may be embodied as, for example, but not be limited to, a website, a web application, a desktop application, and a mobile application compatible with a computing device 3300.

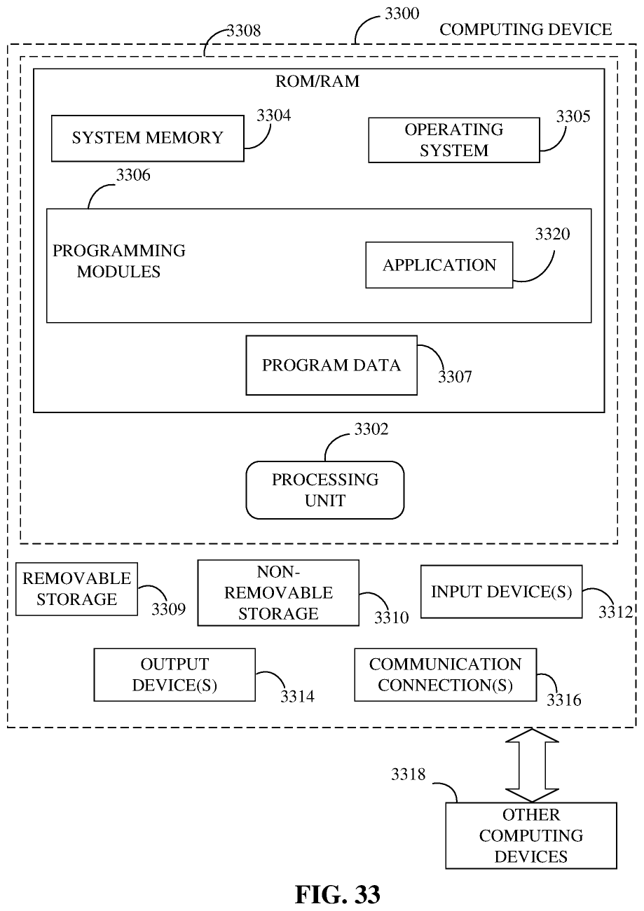

With reference to FIG. 33, a system consistent with an embodiment of the disclosure may include a computing device or cloud service, such as computing device 3300. In a basic configuration, computing device 3300 may include at least one processing unit 3302 and a system memory 3304. Depending on the configuration and type of computing device, system memory 3304 may comprise, but is not limited to, volatile (e.g. random-access memory (RAM)), non-volatile (e.g. read-only memory (ROM)), flash memory, or any combination. System memory 3304 may include operating system 3305, one or more programming modules 3306, and may include a program data 3307. Operating system 3305, for example, may be suitable for controlling computing device 3300's operation. In one embodiment, programming modules 3306 may include image-processing module, machine learning module. Furthermore, embodiments of the disclosure may be practiced in conjunction with a graphics library, other operating systems, or any other application program and is not limited to any particular application or system. This basic configuration is illustrated in FIG. 33 by those components within a dashed line 3308.

Computing device 3300 may have additional features or functionality. For example, computing device 3300 may also include additional data storage devices (removable and/or non-removable) such as, for example, magnetic disks, optical disks, or tape. Such additional storage is illustrated in FIG. 33 by a removable storage 3309 and a non-removable storage 3310. Computer storage media may include volatile and non-volatile, removable and non-removable media implemented in any method or technology for storage of information, such as computer-readable instructions, data structures, program modules, or other data. System memory 3304, removable storage 3309, and non-removable storage 3310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3300. Any such computer storage media may be part of device 3300. Computing device 3300 may also have input device(s) 3312 such as a keyboard, a mouse, a pen, a sound input device, a touch input device, a location sensor, a camera, a biometric sensor, etc. Output device(s) 3314 such as a display, speakers, a printer, etc. may also be included. The aforementioned devices are examples and others may be used.

Computing device 3300 may also contain a communication connection 3316 that may allow device 3300 to communicate with other computing devices 3318, such as over a network in a distributed computing environment, for example, an intranet or the Internet. Communication connection 3316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 3304, including operating system 3305. While executing on processing unit 3302, programming modules 3306 (e.g., application 3320 such as a media player) may perform processes including, for example, one or more stages of methods, algorithms, systems, applications, servers, databases as described above. The aforementioned process is an example, and processing unit 3302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

According to some aspects, a charging apparatus for facilitating charging of electric vehicles is disclosed. Further, the charging apparatus may include a charging structure, at least one solar panel, at least one charging device, at least one sensor, at least one environment sensor, a processing device, and at least one actuator. Further, the charging structure may be movably positionable on a surface of at least one location. Further, the charging structure delimits a charging area on the surface based on positioning of the charging structure on the surface. Further, the at least one solar panel may be movably mounted on the charging structure for extending over at least a part of the charging area. Further, the at least one solar panel may be configured to be transitioned between a plurality of orientations in relation to the charging area. Further, the at least one charging device may be electrically coupled with the at least one solar panel. Further, the at least one charging device may be configured for charging at least one electric vehicle present in the charging area using at least one connector based on receiving electrical energy from the at least one solar panel. Further, the at least one connector electrically couples the at least one charging device to the at least one electric vehicle. Further, the at least one sensor may be configured for generating at least one sensor data based on detecting a position of the at least one electric vehicle in relation to the at least one solar panel after electrically coupling the at least one electric vehicle to the at least one charging device. Further, the at least one environment sensor may be configured for generating at least one environment element data based on detecting at least one environment element associated with an environment of the charging apparatus. Further, the processing device may be communicatively coupled with the at least one sensor and the at least one environment sensor. Further, the processing device may be configured for analyzing the at least one sensor data and the at least one environment element data. Further, the processing device may be configured for determining a modified orientation from the plurality of orientations for the at least one solar panel based on the analyzing. Further, the at least one solar panel in the modified orientation protects the at least one electric vehicle from the at least one environment element. Further, the processing device may be configured for generating at least one command for the at least one solar panel based on the determining. Further, the at least one actuator may be operatably coupled with the at least one solar panel. Further, the at least one actuator may be communicatively coupled with the processing device. Further, the at least one actuator may be configured for transitioning the at least one solar panel from a current orientation of the plurality of orientations of the at least one solar panel to the modified orientation based on the at least one command.

According to further aspects, the charging structure comprises a base and at least one leg. Further, the base comprises at least one movement mechanism for allowing at least one movement to the charging apparatus on the surface.

According to further aspects, the at least one leg comprises a first end and a second end. Further, the first end is attached to the base and the second end extends away from the base. Further, the at least one solar panel is movably attached to the second end of the at least one leg for movably mounting the at least one solar panel on the charging structure.

According to further aspects, the at least one leg comprises at least one main leg portion and at least one extendable leg portion extendably disposed in the at least one main leg portion. Further, the at least one main leg portion comprises the first end and the at least one extendable leg portion comprises the second end. Further, the at least one extendable leg portion retractably extends between a plurality of leg positions in relation to the at least one main leg portion for transitioning the at least one solar panel between a plurality of heights in relation to the charging area.

According to further aspects, the charging apparatus may include at least one first actuator operatably coupled with the at least one main leg portion and the at least one extendable leg portion. Further, the at least one first actuator is communicatively coupled with the processing device. Further, the generating of the at least one sensor data is further based on detecting a height of the at least one electric vehicle. Further, the processing device is configured for determining a modified height from a plurality of heights for the at least one solar panel based on the analyzing of the at least one sensor data. Further, the processing device is configured for determining a leg position from the plurality of leg positions based on the modified height. Further, the processing device is configured for generating at least one first command for the at least one solar panel based on the determining of the leg position. Further, the at least one first actuator is configured for retractably extending the at least one extendable leg portion to the leg position in relation to the at least one main leg portion based on the at least one first command.

According to further aspects, the charging apparatus may include at least one first sensor communicatively coupled with the processing device. Further, the at least one first sensor is configured for generating at least one first sensor data based on detecting at least one location characteristic of the at least one location. Further, the processing device is configured for analyzing the at least one first sensor data. Further, the processing device is configured for determining the at least one location on the surface based on the analyzing of the at least one first sensor data. Further, the processing device is configured for generating at least one second command for the charging structure based on the determining of the at least one location. Further, the at least one movement mechanism is communicatively coupled with the processing device. Further, the at least one movement mechanism is configured for moving the charging apparatus to the at least one location on the surface based on the at least one second command.

According to further aspects, the charging apparatus may include at least one second sensor communicatively coupled with the processing device. Further, the at least one second sensor is configured for generating at least one second sensor data based on detecting a position of the at least one electric vehicle on the at least one location. Further, the processing device is configured for analyzing the at least one second sensor data. Further, the processing device is configured for determining the at least one location on the surface based on the analyzing of the at least one second sensor data. Further, the processing device is configured for generating at least one third command for the charging structure based on the determining of the at least one location. Further, the at least one movement mechanism is communicatively coupled with the processing device. Further, the at least one movement mechanism is configured for moving the charging apparatus to the at least one location on the surface based on the at least one third command.

According to further aspects, the at least one solar panel in the current orientation is tilted away from the charging area with at least one tilt. Further, the at least one environment element comprises snow. Further, the at least one solar panel tilted with the at least one tilt prevents the snow falling on the at least one solar panel from falling on the charging area.

According to further aspects, the charging apparatus may include at least one battery electrically coupled with the at least one charging device. Further, the at least one charging device is configured for transferring the electrical energy received by the at least one charging device to the at least one battery based on a disconnected state of the at least one charging device. Further, the at least one connector is not electrically coupled with the at least one electric vehicle in the disconnected state. Further, the at least one charging device does not transfer the electrical energy to the at least one battery in a connected state of the at least one charging device. Further, the at least one connector is electrically coupled with the at least one electric vehicle in the connected state.

According to further aspects, the at least one charging device is electrically coupled with an electrical grid. Further, the charging of the at least one electric vehicle is further based on receiving electrical energy from the electrical grid.

According to further aspects, the at least one charging device comprises at least one first charging device and at least one second charging device. Further, the charging of the at least one electric vehicle by the at least one first charging device is associated with a first charging speed and the charging of the at least one electric vehicle by the at least one second charging device is associated with a second charging speed. Further, the first charging speed is greater than the second charging speed.

According to further aspects, the charging apparatus may include a solar tracking device communicatively coupled with the processing device. Further, the at least one solar tracking device is configured for generating at least one solar panel data based on detecting a position of the sun in the sky in relation to the at least one location of the at least one location. Further, the at least one solar panel data comprises an orientation recommendation of the at least one solar panel with respect to the sun. Further, the processing device is further configured for analyzing the at least one solar panel data. Further, the determining of the modified orientation of the at least one solar panel is further based on the analyzing of the at least one solar panel data.

According to some aspects, a charging apparatus for facilitating charging of electric vehicles is disclosed. Accordingly, the charging apparatus may include a charging structure, at least one solar panel, at least one charging device, at least one sensor, at least one environment sensor, a processing device, and at least one actuator. Further, the charging structure may be movably positionable on a surface of at least one location. Further, the charging structure delimits a charging area on the surface based on positioning of the charging structure on the surface. Further, the charging structure may include a base and at least one leg. Further, the base may include at least one movement mechanism for allowing at least one movement to the charging apparatus on the surface. Further, the at least one solar panel may be movably mounted on the charging structure for extending over at least a part of the charging area. Further, the at least one solar panel may be configured to be transitioned between a plurality of orientations in relation to the charging area. Further, the at least one charging device may be electrically coupled with the at least one solar panel. Further, the at least one charging device may be configured for charging at least one electric vehicle present in the charging area using at least one connector based on receiving electrical energy from the at least one solar panel. Further, the at least one connector electrically couples the at least one charging device to the at least one electric vehicle. Further, the at least one sensor may be configured for generating at least one sensor data based on detecting a position of the at least one electric vehicle in relation to the at least one solar panel after electrically coupling the at least one electric vehicle to the at least one charging device. Further, the at least one environment sensor may be configured for generating at least one environment element data based on detecting at least one environment element associated with an environment of the charging apparatus. Further, the processing device may be communicatively coupled with the at least one sensor and the at least one environment sensor. Further, the processing device may be configured for analyzing the at least one sensor data and the at least one environment element data. Further, the processing device may be configured for determining a modified orientation from the plurality of orientations for the at least one solar panel based on the analyzing. Further, the at least one solar panel in the modified orientation protects the at least one electric vehicle from the at least one environment element. Further, the processing device may be configured for generating at least one command for the at least one solar panel based on the determining. Further, the at least one actuator may be operatably coupled with the at least one solar panel. Further, the at least one actuator may be communicatively coupled with the processing device. Further, the at least one actuator may be configured for transitioning the at least one solar panel from a current orientation of the plurality of orientations of the at least one solar panel to the modified orientation based on the at least one command.

According to further aspects, the at least one leg comprises a first end and a second end. Further, the first end is attached to the base and the second end extends away from the base. Further, the at least one solar panel is movably attached to the second end of the at least one leg for movably mounting the at least one solar panel on the charging structure.

According to further aspects, the charging apparatus may include at least one first sensor communicatively coupled with the processing device. Further, the at least one first sensor is configured for generating at least one first sensor data based on detecting at least one location characteristic of the at least one location. Further, the processing device is configured for analyzing the at least one first sensor data. Further, the processing device is configured for determining the at least one location on the surface based on the analyzing of the at least one first sensor data. Further, the processing device is configured for generating at least one second command for the charging structure based on the determining of the at least one location. Further, the at least one movement mechanism is communicatively coupled with the processing device. Further, the at least one movement mechanism is configured for moving the charging apparatus to the at least one location on the surface based on the at least one second command.

According to further aspects, the charging apparatus may include at least one second sensor communicatively coupled with the processing device. Further, the at least one second sensor is configured for generating at least one second sensor data based on detecting a position of the at least one electric vehicle on the at least one location. Further, the processing device is configured for analyzing the at least one second sensor data. Further, the processing device is configured for determining the at least one location on the surface based on the analyzing of the at least one second sensor data. Further, the processing device is configured for generating at least one third command for the charging structure based on the determining of the at least one location. Further, the at least one movement mechanism is communicatively coupled with the processing device. Further, the at least one movement mechanism is configured for moving the charging apparatus to the at least one location on the surface based on the at least one third command.

According to further aspects, the at least one solar panel in the current orientation is tilted away from the charging area with at least one tilt. Further, the at least one environment element comprises snow. Further, the at least one solar panel tilted with the at least one tilt prevents the snow falling on the at least one solar panel from falling on the charging area.

According to further aspects, the at least one charging device is electrically coupled with an electrical grid. Further, the charging of the at least one electric vehicle is further based on receiving electrical energy from the electrical grid.

According to further aspects, the charging apparatus may include at least one battery electrically coupled with the at least one charging device. Further, the at least one charging device is configured for transferring the electrical energy received by the at least one charging device to the at least one battery based on a disconnected state of the at least one charging device. Further, the at least one connector is not electrically coupled with the at least one electric vehicle in the disconnected state. Further, the at least one charging device does not transfer the electrical energy to the at least one battery in a connected state of the at least one charging device. Further, the at least one connector is electrically coupled with the at least one electric vehicle in the connected state.

According to some aspects, a charging apparatus for facilitating charging of electric vehicles, in accordance with some embodiments. Accordingly, the charging apparatus may include a charging structure, at least one solar panel, at least one charging device, at least one sensor, at least one environment sensor, a processing device, and at least one actuator. Further, the charging structure may be movably positionable on a surface of at least one location. Further, the charging structure delimits a charging area on the surface based on positioning of the charging structure on the surface. Further, the charging structure may include a base and at least one leg. Further, the base may include at least one movement mechanism for allowing at least one movement to the charging apparatus on the surface. Further, the at least one leg may include a first end and a second end. Further, the first end may be attached to the base and the second end extends away from the base. Further, the at least one solar panel may be movably attached to the second end of the at least one leg for movably mounting the at least one solar panel on the charging structure. Further, the at least one solar panel may be movably mounted on the charging structure for extending over at least a part of the charging area. Further, the at least one solar panel may be configured to be transitioned between a plurality of orientations in relation to the charging area. Further, the at least one charging device may be electrically coupled with the at least one solar panel. Further, the at least one charging device may be configured for charging at least one electric vehicle present in the charging area using at least one connector based on receiving electrical energy from the at least one solar panel. Further, the at least one connector electrically couples the at least one charging device to the at least one electric vehicle. Further, the at least one sensor may be configured for generating at least one sensor data based on detecting a position of the at least one electric vehicle in relation to the at least one solar panel after electrically coupling the at least one electric vehicle to the at least one charging device. Further, the at least one environment sensor may be configured for generating at least one environment element data based on detecting at least one environment element associated with an environment of the charging apparatus. Further, the processing device may be communicatively coupled with the at least one sensor and the at least one environment sensor. Further, the processing device may be configured for analyzing the at least one sensor data and the at least one environment element data. Further, the processing device may be configured for determining a modified orientation from the plurality of orientations for the at least one solar panel based on the analyzing. Further, the at least one solar panel in the modified orientation protects the at least one electric vehicle from the at least one environment element. Further, the processing device may be configured for generating at least one command for the at least one solar panel based on the determining. Further, the at least one actuator may be operatably coupled with the at least one solar panel. Further, the at least one actuator may be communicatively coupled with the processing device. Further, the at least one actuator may be configured for transitioning the at least one solar panel from a current orientation of the plurality of orientations of the at least one solar panel to the modified orientation based on the at least one command.

Although the present disclosure has been explained in relation to its preferred embodiment, it is to be understood that many other possible modifications and variations can be made without departing from the spirit and scope of the disclosure.

What is claimed is:

1. A charging apparatus for facilitating charging of electric vehicles, the charging apparatus comprising:
a charging structure movably positionable in on a surface of a location, wherein the charging structure comprises at least one leg movably erected on the surface and at least one roof structure supported on the at least one leg, wherein each of the at least one roof structure corresponding to each of the at least one leg comprises two frame pairs, wherein a first frame pair of two frame pairs laterally extends away from a first side of a top end of each of the at least one leg and a second frame pair of the two frame pairs laterally extends away from a second side opposite to the first side of the top end, wherein the first frame pair and the second frame pair are upwardly inclined with respect to each of the at least one leg, wherein each of the first frame pair and the second frame pair comprises a first frame and a second frame attached to the first frame forming an attachment axis, wherein the first frame and the second frame are upwardly inclined with respect to attachment axis;
at least one solar panel mounted on the at least one roof structure, wherein the at least one solar panel comprises two solar panel pairs, wherein a first solar panel pair of the two solar panel pairs are attached in the first frame pair and a second solar panel pair of the two solar panel pairs are attached in the second frame pair, wherein a first solar panel of each of the first solar panel pair and the second solar panel pair is attached in the first frame and a second solar panel of each of the first solar panel pair and the second solar panel pair is attached in the second frame; and
one or more charging stations electrically coupled with at least one of the at least one solar panel and an electrical grid, wherein the one or more charging stations is configured for:
receiving electrical energy from at least one of the at least one solar panel and the electrical grid; and
charging one or more electric vehicles using one or more connectors based on the receiving of the electrical energy, wherein the one or more connectors electrically connects the one or more charging stations to one or more charging ports of the one or more electric vehicles.

2. The charging apparatus of claim 1, wherein the mounting of the at least one solar panel on the at least one roof structure defines a recessed area on a top side of the at least one roof structure, wherein each of the at least one leg comprises a hollow interior, a top opening disposed on the top end, and a bottom opening disposed on a bottom end of each of the at least one leg, wherein the top opening and the bottom opening are fluidly coupled through the hollow interior, wherein the recessed area collects at least one precipitation falling on the top side of the at least one roof structure and removes the at least one precipitation through the hollow interior based on transferring the at least one precipitation to the hollow interior from the top opening and exiting the at least one precipitation from the hollow interior through the bottom opening.

3. The charging apparatus of claim 1, wherein the at least one roof structure is detachably supported on the at least one leg.

4. The charging apparatus of claim 1, wherein the at least one solar panel comprises a bifacial solar panel.

5. The charging apparatus of claim 1, wherein the one or more charging stations is associated with one or more charging rates, wherein the charging of the one or more electric vehicles using the one or more connectors comprises charging the one or more electric vehicles with the one or more charging rates using the one or more connectors based on the receiving of the electrical energy, wherein the one or more charging rates comprises a first charging rate associated with a first charging station of the one or more charging stations and a second charging rate associated with a second charging station of the one or more charging stations, wherein the first charging rate is higher than the second charging rate.

6. The charging apparatus of claim 1, wherein each of the first solar panel and the second solar panel is associated with at least one orientation based on the upwardly inclining of the first frame and the second frame with respect to the attachment axis and the upwardly inclining of the first frame pair and the second frame pair with respect to each of the at least one leg, wherein the at least one solar panel generates the electrical energy with an efficiency based on the at least one orientation of each of the first solar panel and the second solar panel.

7. The charging apparatus of claim 1 further comprising:
at least one first sensor configured for generating at least one first sensor data based on detecting at least one parameter associated with the receiving of the electrical energy;
a processing device communicatively coupled with the at least one first sensor, wherein the processing device is configured for:
analyzing the at least one first sensor data; and
generating an energy generation report associated with the receiving of the electrical energy based on the analyzing; and
a communication device communicatively coupled with the processing device, wherein the communication device is configured for transmitting the energy generation report to at least one device.

8. The charging apparatus of claim 7 further comprising at least one second sensor communicatively coupled with the processing device, wherein the at least one second sensor is configured for generating at least one second sensor data based on detecting at least one charging parameter associated with the charging of the one or more electric vehicles, wherein the processing device is further configured for:
analyzing the at least one second sensor data; and
generating a charging report associated with the charging of the one or more electric vehicles based on the analyzing of the at least one second sensor data, wherein the communication device is further configured for transmitting the charging report to the at least one device.

9. The charging apparatus of claim 8, wherein the communication device is further configured for receiving at least one of a plurality of energy generation reports and a plurality of charging reports associated with a plurality of charging apparatuses from the at least one device, wherein the plurality of charging apparatuses is located in a plurality of locations, wherein the processing device is further configured for:
analyzing at least one of the plurality of energy generation reports and the plurality of charging reports;
determining a viability of the charging apparatus in the location based on the analyzing of at least one of the plurality of energy generation reports and the plurality of charging reports; and
generating a recommendation for the charging apparatus based on the determining, wherein the communication device is further configured for transmitting the recommendation to the at least one device.

10. The charging apparatus of claim 1 further comprising at least one kiosk installed on the charging structure, wherein each of the at least one kiosk comprises:
at least one input device configured for generating at least one service request associated with at least one service;
a processing device communicatively coupled with the at least one input device, wherein the processing device is configured for:
analyzing the at least one service request;
identifying at least one service provider from a plurality of service providers based on the analyzing; and
generating at least one order of the at least one service for the at least one service provider based on the identifying;
a communication device communicatively coupled with the processing device, wherein the communication device is configured for transmitting the at least one order to at least one service provider device associated with the at least one service provider.

11. The charging apparatus of claim 10, wherein each of the at least one kiosk comprises a storage device communicatively coupled with the processing device, wherein the storage device is configured for:
retrieving a plurality of service provider information associated with the plurality of service providers; and
retrieving the location of the charging apparatus, wherein the processing device is further configured for:
analyzing the plurality of service provider information and the location; and
determining at least one value for at least one parameter associated with a suitability of each of the plurality of service providers based on the analyzing of the plurality of service provider information and the location, wherein the identifying of the at least one service provider from the plurality of service providers is further based on the determining.

12. The charging apparatus of claim 1, wherein the at least one roof structure comprises a first roof structure and a second roof structure, wherein a first peripheral side of the first roof structure may be attached to a second peripheral side of the second roof structure, wherein the at least one leg comprises a first leg and second leg, wherein the first roof structure is supported on the first leg and the second roof structure is supported on the second leg.

13. A charging apparatus for facilitating charging of electric vehicles, the charging apparatus comprising:
a charging structure movably positionable in on a surface of a location, wherein the charging structure comprises at least one leg movably erected on the surface and at least one roof structure supported on the at least one leg, wherein each of the at least one roof structure corresponding to each of the at least one leg comprises two frame pairs, wherein a first frame pair of two frame pairs laterally extends away from a first side of a top end of each of the at least one leg and a second frame pair of the two frame pairs laterally extends away from a second side opposite to the first side of the top end, wherein the first frame pair and the second frame pair are upwardly inclined with respect to each of the at least one leg, wherein each of the first frame pair and the second frame pair comprises a first frame and a second frame attached to the first frame forming an attachment axis, wherein the first frame and the second frame are upwardly inclined with respect to attachment axis;
at least one solar panel mounted on the at least one roof structure, wherein the at least one solar panel comprises two solar panel pairs, wherein a first solar panel pair of the two solar panel pairs are attached in the first frame pair and a second solar panel pair of the two solar panel pairs are attached in the second frame pair, wherein a first solar panel of each of the first solar panel pair and the second solar panel pair is attached in the first frame and a second solar panel of each of the first solar panel pair and the second solar panel pair is attached in the second frame;
one or more charging stations electrically coupled with at least one of the at least one solar panel and an electrical grid, wherein the one or more charging stations is configured for:
receiving electrical energy from at least one of the at least one solar panel and the electrical grid; and
charging one or more electric vehicles using one or more connectors based on the receiving of the electrical energy, wherein the one or more connectors electrically connects the one or more charging stations to one or more charging ports of the one or more electric vehicles;
at least one first sensor configured for generating at least one first sensor data based on detecting at least one parameter associated with the receiving of the electrical energy;
a processing device communicatively coupled with the at least one first sensor, wherein the processing device is configured for:
analyzing the at least one first sensor data; and
generating an energy generation report associated with the receiving of the electrical energy based on the analyzing; and
a communication device communicatively coupled with the processing device, wherein the communication device is configured for transmitting the energy generation report to at least one device.

14. The charging apparatus of claim 13, wherein the mounting of the at least one solar panel on the at least one roof structure defines a recessed area on a top side of the at least one roof structure, wherein each of the at least one leg comprises a hollow interior, a top opening disposed on the top end, and a bottom opening disposed on a bottom end of each of the at least one leg, wherein the top opening and the bottom opening are fluidly coupled through the hollow interior, wherein the recessed area collects at least one precipitation falling on the top side of the at least one roof structure and removes the at least one precipitation through the hollow interior based on transferring the at least one precipitation to the hollow interior from the top opening and exiting the at least one precipitation from the hollow interior through the bottom opening.

15. The charging apparatus of claim 13, wherein the at least one roof structure is detachably supported on the at least one leg.

16. The charging apparatus of claim 13, wherein the at least one solar panel comprises a bifacial solar panel.

17. The charging apparatus of claim 13, wherein the one or more charging stations is associated with one or more charging rates, wherein the charging of the one or more electric vehicles using the one or more connectors comprises charging the one or more electric vehicles with the one or more charging rates using the one or more connectors based on the receiving of the electrical energy, wherein the one or more charging rates comprises a first charging rate associated with a first charging station of the one or more charging stations and a second charging rate associated with a second charging station of the one or more charging stations, wherein the first charging rate is higher than the second charging rate.

18. The charging apparatus of claim 13, wherein each of the first solar panel and the second solar panel is associated with at least one orientation based on the upwardly inclining of the first frame and the second frame with respect to the attachment axis and the upwardly inclining of the first frame pair and the second frame pair with respect to each of the at least one leg, wherein the at least one solar panel generates the electrical energy with an efficiency based on the at least one orientation of each of the first solar panel and the second solar panel.

19. The charging apparatus of claim 13 further comprising at least one second sensor configured for generating at least one second sensor data based on detecting at least one charging parameter associated with the charging of the one or more electric vehicles, wherein the processing device is further configured for:
analyzing the at least one second sensor data; and
generating a charging report associated with the charging of the one or more electric vehicles based on the analyzing of the at least one second sensor data, wherein the communication device is further configured for transmitting the charging report to the at least one device.

20. The charging apparatus of claim 19, wherein the communication device is further configured for receiving at least one of a plurality of energy generation reports and a plurality of charging reports associated with a plurality of charging apparatuses from the at least one device, wherein the plurality of charging apparatuses is located in a plurality of locations, wherein the processing device is further configured for:
analyzing at least one of the plurality of energy generation reports and the plurality of charging reports;
determining a viability of the charging apparatus in the location based on the analyzing of at least one of the plurality of energy generation reports and the plurality of charging reports; and
generating a recommendation for the charging apparatus based on the determining, wherein the communication device is further configured for transmitting the recommendation to the at least one device.
